(19) United States
(12) Patent Application Publication
(10) Pub. No.: US 2018/0089629 A1
(43) Pub. Date: Mar. 29, 2018

(54) Computer-Mediated Tool for Determining Promotions

(71) Applicant: Unitive, Inc., Woodside, CA (US)

(72) Inventors: Laura Anne Mather, Woodside, CA (US); Catherine Paige Panter, San Francisco, CA (US); Samuel Davis Panter, San Francisco, CA (US); James Schumacher, Oakland, CA (US); Daniel Joong-Hee Kim, South San Francisco, CA (US)

(73) Assignee: Unitive, Inc., Woodside, CA (US)

(21) Appl. No.: 15/809,963

(22) Filed: Nov. 10, 2017

Related U.S. Application Data
(63) Continuation of application No. 14/835,464, filed on Aug. 25, 2015.
(60) Provisional application No. 62/195,686, filed on Jul. 22, 2015.
(60) Provisional application No. 62/159,208, filed on May 8, 2015.
(60) Provisional application No. 62/130,429, filed on Mar. 9, 2015.
(60) Provisional application No. 62/085,822, filed on Dec. 1, 2014.
(60) Provisional application No. 62/058,463, filed on Oct. 1, 2014.
(60) Provisional application No. 62/041,515, filed on Aug. 25, 2014.

(51) Int. Cl. G06Q 10/10

(52) U.S. Cl. CPC G06Q 10/1053

(57) ABSTRACT

The inherent human biases related to hiring processes are mediated using automated computer based systems. Computer executed logic is configured to detect and compensate for, for example, cultural, gender, and/or racial biases. Specific applications include, but are not limited to, job descriptions, review of resumes and interviews.

### CROSS-REFERENCE TO RELATED APPLICATIONS

This application is a continuation of U.S. patent application Ser. No. 14/835,464 filed Aug. 25, 2015 which claims the benefit of and priority to U.S. Provisional Patent Application No. 62/041,515 filed Aug. 25, 2014; U.S. Provisional Patent Application No. 62/058,463 filed Oct. 1, 2014; U.S. Provisional Patent Application No. 62/085,822 filed Dec. 1, 2014; U.S. Provisional Patent Application No. 62/130,429 filed Mar. 9, 2015; U.S. Provisional Patent Application No. 62/159,208 filed May 8, 2015; and U.S. Provisional Patent Application No. 62/195,686 filed Jul. 22, 2015. The disclosures of the above provisional patent applications are hereby incorporated herein by reference.

### BACKGROUND

### Field of the Invention

The invention is in the field of computer mediated human resource management, and specifically in the field of computer mediated hiring processes.

### Related Art

Hiring processes inherently include human biases. Such biases can be cultural, gender based, racial and/or based on some other category. Even the best intentioned people are likely to introduce subconscious bias into their work. Such bias has negative consequences. For example, it may result in selecting a sub-optimal candidate for a job opening. Bias may be found in the preparation of job descriptions, review of resumes and interviews.

### SUMMARY

Various embodiments of the invention include a computing system configured to facilitate the preparation of job descriptions, the review of resumes and/or the conducting and analysis of interviews. For example, various embodiments of the invention provide a computer based job description authoring tool configured to reduce the inherent bias that is often found in job descriptions prepared by human authors. The authoring tool is configured to guide a human author in the preparation of job descriptions. This guidance includes, for example, crafting of language having reduced bias, scoring language for bias content, and providing suggestions for language including less bias. A purpose, of some embodiments, is to generate job descriptions that include less bias than job descriptions that would typically be generated by a human author alone.

Various embodiments of the invention include a computing system configured to reduce bias in the authoring of job descriptions, the computing system comprising a user interface configured for a human user to enter words of a job description; a rule base comprising a plurality of rules for the content of a job description, the plurality of rules including 1) a rule limiting a number of requirements listed in the job description, 2) a rule to avoid specific terms in the job description, and/or 3) a rule to avoid specific limits in the job description; analysis logic configured to generate a score for the job description, the score being based on compliance of the job description to the plurality of rules; storage configured to store the job description and the plurality of rules; and a microprocessor configured to execute at least the analysis logic.

Various embodiments of the invention include a computer-based tool for reviewing resumes and configured to reduce the inherent bias that occurs when humans review resumes to determine applicable candidates for a job. The review tool is configured to allow the human reviewer to examine resumes without or greatly reduced influence of the biases that are typically inherent in the reviewer. The techniques for removing biases include, for example, having the reviewer pre-commit to the components of the resume that are most indicative of whether the candidate will be a good fit for the job and not letting one component of the resume influence what the reviewer thinks about other components of the resume. A purpose, of some embodiments, is to create a final rank order of a set of resumes that is in order of the likelihood that the job candidate will perform well in the job for which he or she is applying.

Various embodiments of the invention include a computing system configured to reduce bias in the review of resumes, the computing system comprising: a user interface configured to a human user to interact with components of job candidate resumes including reading the resume component, viewing the resume component relative to components of other resumes, and/or ranking the components of resumes relative to each other; analysis logic configured to generate a score for each resume, the score being based on the relative rankings of each component of the resume compared with other resumes; a user interface configured to display resumes being considered in an order determined by the analysis logic; storage configured to store the resumes, the rankings of the components of the resumes and logic for computing the scores associated with resumes; and a microprocessor configured to execute at least the analysis logic.

Various embodiments of the invention provide a computer-based tool for conducting interviews, phone screens, and/or reference checks for job candidates. This tool is configured to reduce the inherent bias that occurs when humans conduct these various types of interviews to determine applicable candidates for a job. The interview, phone screen, or reference check tool is configured to allow the human interviewer to perform these interviews, phone screens or reference checks without, or with greatly reduced influence of the biases that are typically inherent in the interviewer. The techniques for removing biases include, for example, ensuring that the interviewer asks either behavior-based or performance-based interview questions, ensuring that the interviewer asks the same questions of all candidates, prompting an interviewer to give specific reasons around “culture fit” or lack thereof, and creating accountability within the interview, phone screen, or reference check process. A purpose, of some embodiments, is to create a more cohesive interview, phone screen, or reference check experience for the job candidate, which can also attract the highest quality candidates to the position.

Various embodiments of the invention include a computing system configured to reduce bias in the interviewing, phone screening, and/or reference checking of candidates, the computing system comprising: a user interface configured for a human user to interact with components of job candidate interviews, phone screens, and/or reference checks including determining the questions to be used during the interview/screen/check by each interviewer, and notifying each interviewer as to the format of the interview/screen/check; a user interface configured to a human user to interact with components of j ob candidate interviews, phone screens, and/or reference checks including allowing each interviewer to provide feedback on the interview/screen/check of the candidate; analysis logic that looks for the use of particular phrases like “not a culture fit” and prompts the interviewer for specifics; analysis logic configured to generate a score for each interview/check/screen, the score being based on the relative rankings of answer provided by the candidate to each interviewer compared with answers provided by other candidates; a user interface configured to display feedback from interviewers on candidates; a user interface configured to display candidates being considered in an order determined by the analysis logic; storage configured to store the candidates, the rankings of the candidates and logic for computing the scores associated with candidates; and a microprocessor configured to execute at least the analysis logic.

### BRIEF DESCRIPTION OF THE DRAWINGS

FIG. 1 illustrates an human resources system, according to various embodiments of the invention.

FIG. 2 illustrates an example of a job description management module, according to various embodiments of the invention.

FIG. 3 illustrates a method of authoring a job description, according to various embodiments of the invention.

FIG. 4 is an illustration of a method of comparing job descriptions, according to various embodiments of the invention.

FIG. 5 is a block diagram illustrating a resume review module, according to various embodiments of the invention.

FIG. 6 illustrates a method of a method of providing a set of resumes to a reviewer, according to various embodiments of the invention.

FIG. 7 illustrates a method of comparing a full set of resumes with corresponding scores, according to various embodiments of the invention.

FIG. 8 is a block diagram of a candidate Interview Module, according to various embodiments of the invention.

FIG. 9 illustrates a method of entering feedback on a candidate based on a job interview, phone screen, or reference check, according to various embodiments of the invention.

FIG. 10 illustrates a method of viewing the final feedback of the interview(s), phone screen(s) or reference check(s) of a candidate or set of candidates.

FIG. 11 is a block diagram illustrating a promotion determination system, according to various embodiments of the invention.

FIG. 12 illustrates a method for prompting a promotion board to rate various candidates being considered for promotion, according to various embodiments of the invention.

FIG. 13 illustrates a method for selecting a candidate to be promoted, according to various embodiments of the invention.

FIG. 14 illustrates a method for adjusting the ratings associated the candidates being considered for promotion, according to various embodiments of the invention.

FIG. 15 illustrates a system for viewing ratings or grades that indicate the bias present in process of determining promotions, according to various embodiments of the invention.

### DETAILED DESCRIPTION

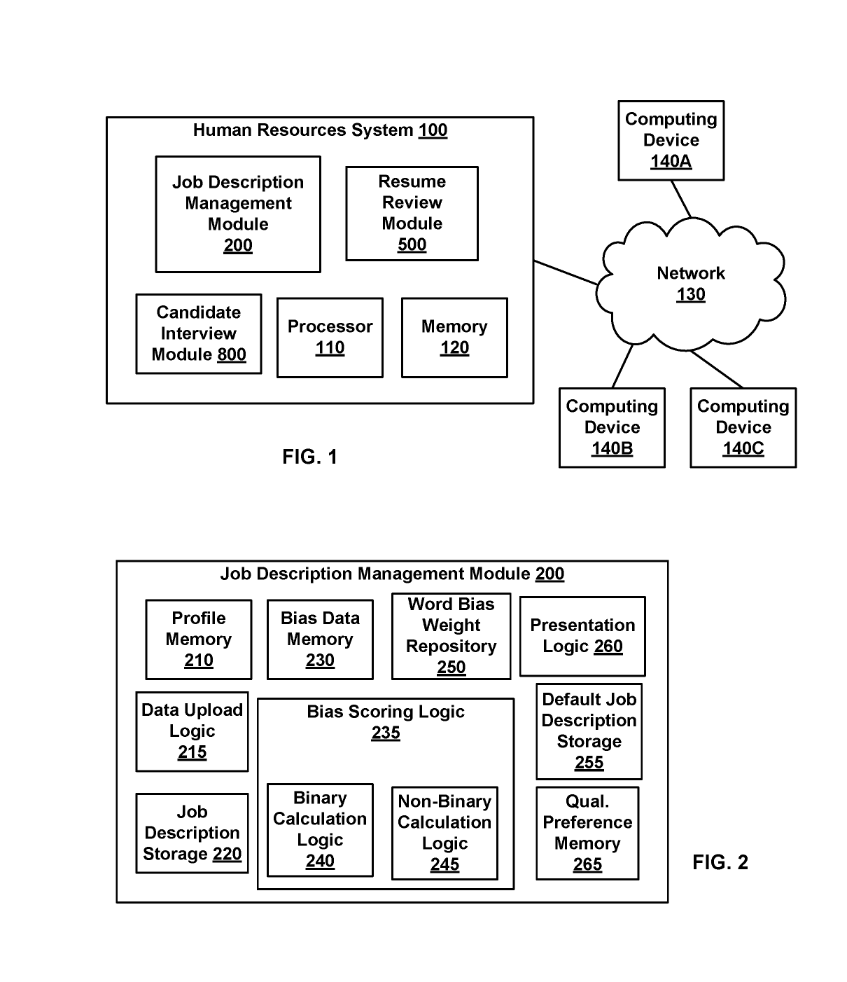

FIG. 1 is a block diagram illustrating a Human Resources System 100. Human Resources System 100 includes a Job Description Management Module 200, a Resume Review Module 500 and a Candidate Interview Module 400. Human Resource System 100 may include a personal computer, a server, a web server, a file server, a distributed computing system connected by a network, a communication device, and/or the like. Human Resources System 100 further includes at least one Processor 110 and Memory 120. Processor 110 includes a microprocessor, an ASIC, a programmable logic array, a communication circuit, a central processing unit, and/or the like. Processor 110 is typically configured to perform specific tasks by the addition of software and/or firmware. For example, Processor 110 may be configured to execute the logic discussed herein. Memory 120 may include random access memory, static memory, non-volatile memory, volatile memory, a hard drive, an optical drive, magnetic media, optical media, and/or other digital storage devices. As described elsewhere herein, Memory 120 may include data structures configured to store specific data.

The various modules included in Human Resource System 100 each consist of hardware (such as parts of Memory 120) and logic configured to perform specific functions described herein. The modules may be configured to be executed (operated) independently and/or may be integrated such that certain resources (hardware or logic) are shared. The various logical elements included in Human Resource System 100 consist of hardware, firmware, and/or software stored on a non-transient computer readable medium. For example, Human Resources System 100 can include a microprocessor specifically configured to perform the functions of Resume Review Module 500 by the addition of specific purpose software. The various logic elements included in Human Resource System 100 may be integrated or may be configured in separate, independently executable modules.

Human Resources System 100 is configured to communicate over a Network 130. Network 130 may include the internet, a wireless network, a telephone network, a computer network, a local area network, and/or the like. Optionally, Network 130 is configured for communication via IP/TCP protocols. Human Resources System 100, and the various modules therein, may be accessed using Computing Devices 140, such as a user's personal computer, cellular phone, tablet computer, telephone, or the like. Computing Devices 140 are optionally configured to execute a browser such as Internet Explorer™ or FireFox™ and communicate with Human Resources System 100 via this browser. Computing Devices 140 are optionally configured to execute an application which is specifically configured to execute on a cellular phone or other personal computing device that receives data through a cellular telephone network or a local area network. Computing Devices 140 are individually identified as Computing Device 140A, Computing Device 140B, etc.

FIG. 2 illustrates an example of Job Description Management Module 200, according to various embodiments of the invention. Job Description Management Module 200 may include a personal computer, a server, a web server, a file server, a distributed computing system connected by a network, a communication device, and/or the like. In some embodiments, Job Description Management Module 200 is configured to be accessed over Network 130 from one or more of Computing Devices 140. Job Description Management Module 200 is optionally configured to execute computing instructions using Processor 110 and/or to store data on Memory 120

Job Description Management Module 200 includes a Profile Memory 210 configured to store an author's profile (the term author is used to refer to the human author of the job description). Profile Memory 210 is optionally part of Memory 120. Profile Memory 210 may be configured to store a database of profiles associated with a plurality of authors. The author profiles include author identification information such as an author login name, an author's name, an identification number, an account name, a password, and/or the like.

The author profiles typically further include professional and/or personal information regarding the author. This professional and/or personal information can include, but is not limited to the person's job title, the name of the company in which the person is employed, the name of the organization within the company in which the person is employed, the name and identification number of the person's immediate supervisor, the person's gender, the person's birth date, the date of employment for this person at this company, information identifying the person's previous employment history, information identifying the person's education, information about the person's employment performance at this organization, results of various psychological, personality, and other tests completed by the person, the person's race and/or other information that may identify any biases that may arise from this person. One or more of the tests completed by the person are typically configured to identify biases of that person.

The information may have been entered into the Profile Memory 210 when it was provided by a human resources staff, the person or by the person's supervisor via a browser. Some embodiments of the invention include Data Upload Logic 215 configured to automatically upload profile data into Profile Memory 210. For example, Data Upload Logic 215 may be configured to automatically parse a resume, an employee history, and/or other data source and store this information in Profile Memory 210. Data Upload Logic 215 is optionally, configured to upload the data associated with one or more author profiles into Profile Memory 210.

An author profile may include information that the author was born on Jan. 1, 1971, is female, has been employed with the Acme Corporation since Jan. 1, 2003 and held the title of Director of Engineering from Jan. 1, 2003 to Jan. 1, 2005, the title of Sr. Director of Engineering from Jan. 1, 2005 to Jul. 31, 2009, and Vice President of Engineering from Aug. 1, 2009 to the present. Example information that could indicate the author's bias includes, but is not limited to, where the author went to school, the ethnicity of the author, any religious affiliations of the author, any cultural or athletic affiliations of the author, indication of the author's socio-economic background, results of personality, psychological, or other tests that might indicate various types of biases, feedback from co-workers and managers, etc.

Job Description Management Module 200 further includes a Job Description Storage 220 configured to store a job description. Job Description Storage 220 is optionally part of Memory 120. Job Description Storage 220 is optionally configured to store a database of job descriptions associated with a plurality of jobs. The job profiles include job description identification information including the title of the job, the company for which the job will be associated, the organization within the company for which the job will be associated, the description of the job, the experience required to perform the job, the education required to perform the job, the soft skills required to perform the job, the nice-to-haves for potential applicants for the job, a score of the amount of bias in the job description and/or the like.

The information may have been entered into the Job Description Storage 220 when it was provided by the person responsible for creating the job description via a browser. Alternately, it may have been entered into the Job Description Storage 220 by another process. Data Upload Logic 215, is optionally further configured to upload the data associated with one or more author job descriptions into the Job Description Storage 220.

In one embodiment of the invention, after a set of job descriptions is uploaded into Job Description Storage 220 a human resources professional, company brand manager, or some set of similar people review the possible components of the job descriptions. The review process for these components is the same as described herein for a full job description where each component is reviewed on its own merit and then stored in Job Description Storage 220 for later use in creating job descriptions.

Job descriptions stored in Job Description Storage 220 are optionally grouped in job description “families.” Job description families may include job descriptions in the same company, in the same organization, having similar requirements and/or responsibilities, with the same job title, in the same company division, in the same location, or any multidimensional combination of the above.

Job Description Management Module 200 further includes Bias Data Memory 230 configured to store information about various forms of biases, various indicators of those biases, various techniques for mitigating those biases and various descriptions of the biases, and/or the reasoning behind the biases and the mechanisms for mitigating the biases. The information in Bias Data Memory 230 is optionally used by any of the modules within Human Resources System 100.

The Bias Data Memory 230 optionally contains one or more of the following: words and/or phrases that are known to be either male- or female-biased, words or phrases that indicate an age group preference, the maximum number of requirements for various components of the job description (which is configurable by the company or other entity deploying the system), components of the job description that must be included to make the job description less biased (for example, how performance is tracked or a picture of a diverse team), the fact that including at least one “soft skill” (for example, communicates well, builds great teams, etc.) can increase the number of women and minorities that apply, the fact that giving ranges of years of experience can reduce the number of qualified applicants that apply for a job, the fact that adding “or equivalent” to qualifications around experience or education can increase the number of qualified applicants for a job, etc. In the case of job descriptions, “qualifications” describes the various qualities of a candidate that are desirable for a job. Qualifications can be, but are not limited to, experience, education, technical skills, soft skills, certifications, and other such qualities. In some cases it is also desirable to avoid specific limits in a job description. “Specific limits” are, for example, requirements that a candidate be less than 30 years old or have at least 8 years of experience in a specific field.

The Bias Data Memory 230 optionally contains mitigation techniques for removing bias from a job description. Examples of a mitigation techniques include but are not limited to changing a female or male-biased term to a neutral term (for example, changing “fast paced environment” to “productive environment” or changing “aggressive” to “assertive”), adding additional female-biased terms to balance out the male-biased terms, removing terms that indicate an age preference (for example, “digital native”), adding “or equivalent” to the end of statements about experience or education, adding a “soft skill” as a qualification, adding a photograph that includes the representation of a diverse set of employees, restricting the number of requirements for various components of the job descriptions, etc.

Job Description Management Module 200 further includes Bias Scoring Logic 235 configured to parse job descriptions and to calculate a score that is the indication of the amount of bias present in the job description (a bias score). In some embodiments, Bias Scoring Logic 235 includes computer code configured to present a web interface to a user within a browser. In some embodiments, Bias Scoring Logic 235 includes computer code configured to present an interface to a person through their cellular telephone or other telecommunication device. In this case there is often an application, which is part of Job Description Management Module 200, that is used on the phone or other communication device.

Example calculations that can be performed by the Bias Scoring Logic 235 include, but are not limited to, the combination of male- or female-biased terms and the lack of a photograph depicting diverse employees. Or, having more than the maximum number of requirements in a particular section of the job description. Or, detection of a reasonable balance between the use of male and female gender oriented terms. Similarly, counting the number of education or experience qualifications that don't include the phrase “or equivalent”. Also, not including any “soft skills” as part of the required or preferred qualifications for the job. An additional example uses the potential biases of the author to increase or decrease the score based on some component of the job description. For example, if the author has a degree from Harvard, it may be scored as more biased that the requirements list that the applicant must have a degree from an Ivy League School.

In some embodiments, as a first step to building a job description, the author of the job description is asked to specify the competencies that are required for the job that will be described by the job description. Examples of competencies include, but are not limited to, technical skills (“java”, “glass blowing”, “twitter”), personal skills (“team building”, “collaboration”), experience (“has increased sales by 20%”, “has written operating systems that support multi-threading”), certifications (“certified in backhoe driving”, “certified as a CPA”), etc. Specifying competencies at the outset helps the author of the job description be specific about what is required for the job. In some embodiments, the competencies can be ranked against each other either by assigning them scores (for example, decimal numbers between 1 and 10), dragging and dropping them in relation to each other, or a multitude of other ways for ranking them. The resulting competencies and ranks of these competencies are stored in Job Description Storage 220 in association with the job to which they refer.

In some embodiments the possible content for job descriptions is created in advance, either by someone like a human resources professional writing it or job descriptions that have been written previously are parsed and stored in the system. A system of this type is similar to a content management system where the text associated with potential components of job descriptions is stored in Job Description Storage 220. As job descriptions are created from this content those job descriptions are stored. In addition as potential components of the job descriptions are modified, these new potential descriptions are also stored for future use. Storing the job description content in this manner allows human resource professionals and brand managers for a company to be sure that the job description content is appropriate and adheres to the branding requirements of the company.

An author may start with components of a job description that have been stored in the system and/or modify various components of a job description. The components of the job description can be pulled from Job Description Storage 220 for display to the author wherein the author can choose to include, exclude, or modify content for the job description being built.

The calculation of the bias score is based on the information stored in the Bias Data Memory 230 in combination with the various components of the job description. In various embodiments, there are a wide variety of methods by which a score can be calculated. In some embodiments an equation (e.g., a linear equation) is used that includes bias values multiplied by coefficients. The coefficients are based on information such as magnitude of bias per component or number of existing components that represent bias among others.

The score calculated using Bias Scoring Logic 235 is typically configured for showing the user of the system, who is the author or modifier of the job description, when their changes or additions to a job description make that job description more or less biased. The score generated by Bias Scoring Logic 235 can optionally displayed in real-time and/or be displayed based on a previous calculation. Bias Scoring Logic 235 is optionally configured to calculate a grade based on a score. A grade is a representation of a score normalized to a grading scale such as A to F, 1 to 10, one star to five stars, “Very Good” to “Very Bad,” etc.

Bias Scoring Logic 235 optionally includes Binary Calculation Logic 240 and a Non-Binary Calculation Logic 245. Binary Calculation Logic 240 is configured to calculate a score based on binary values, such as the presence of a particular words or phrases in the job description. For example, a job description may include words or phrases like “hard-core” or “best of the best” or “ninj a” which have been shown to decrease female respondents to the job description. In this case, a binary score of one may be included indicating that the job description would be seen as very undesirable to females. Binary Calculation Logic 240 may use Boolean logic. Binary Calculation Logic 240 is typically used to dramatically alter scores for specific components of the job description that are preferably or absolutely to be avoided. Different factors can be weighted differently in the calculation.

Binary Calculation Logic 240 optionally includes whether or not at least one photo is included in the job description in which at least one of the photos shows diversity amongst the participants in the photo. It is shown that a photo with diverse participants can increase the female applicants to a job.

Binary Calculation Logic 240 optionally includes logic configured for determining whether or not performance objectives for the job are included in the job description. If performance objectives for the job are not included in the job description it is possible that the job will be less appealing to females.

Binary Calculation Logic 240 optionally includes logic configured for determining whether or not how performance on the job will be tracked. If how performance is tracked is included in the job description it is more likely to be of interest to some demographics, i.e., females.

Binary Calculation Logic 240 optionally includes logic configured for determining whether or not some description is given of the qualities of the best people in this role. Describing the qualities of the best people in the role—without making this a list of requirements—makes a job more attractive to women.

Binary Calculation Logic 240 is optionally configured to calculate scores based on whether the author has the possibility of being biased in any way. These calculations are based on a plethora of information in the author's profile including but not limited to the author's background, ethnicity, religion, preferences, results of psychological, personality or other tests, indications from the author's co-workers or managers, etc. This information can be used to increase or decrease the bias score based on whether or not the author is likely to have a particular bias.

Non-Binary Calculation Logic 245 is configured to calculate a score based on quantitative information within the job description. For example, the calculation of a score may include multiplying the number of skills required by a coefficient. The coefficient can be positive or negative. For example, in some circumstances a job description with more than three required skills is seen as being less desirable to female candidates. Therefore, the number of skills required beyond three may be multiplied by a coefficient and added to the bias score to indicate an increase in bias in the job description due to too many required skills.

Non-Binary Calculation Logic 245 is optionally configured to calculate scores based on whether the introductory text in the job description is “invitational”. Descriptions that are “invitational” include terms like “join” and “team” among many others. The amount of invitational text within the introductory text could be multiplied by a negative multiplier to indicate a reduction in bias in the introductory section.

Non-Binary Calculation Logic 245 is optionally configured to calculate scores based whether the job description appears to be in “lay-person” language or is more targeted towards the expert in the field. The calculation logic will include a coefficient multiplied by the amount of “expert language” detected within the job description. It has been shown that job descriptions that include language targeted towards experts are less likely to attract females.

Non-Binary Calculation Logic 245 is optionally configured to calculate scores based on the number of responsibilities listed in the job description. For example, in some circumstances, up to three responsibilities is deemed unbiased in a job description, but as additional responsibilities beyond three are added, the job becomes less desirable to females. Therefore, a coefficient may be multiplied by the number of requirements for the job beyond three requirements.

Non-Binary Calculation Logic 245 is optionally configured to calculate scores based on the number of technical skills listed as required in the job description. For example, in some circumstances, up to three technical skills required is deemed unbiased in a job description, but as additional required technical skills beyond three are added, the job becomes less desirable to females. Therefore, a coefficient may be multiplied by the number of skills required for the job beyond three skills.

Non-Binary Calculation Logic 245 is optionally configured to calculate scores based on the number qualifications listed as required in the job description. For example, in some circumstances, up to three qualifications required is deemed unbiased in a job description, but as additional qualifications beyond three are added, the job becomes less desirable to females. Therefore, a coefficient may be multiplied by the number of qualifications for the job beyond three qualifications.

Non-Binary Calculation Logic 245 is optionally configured to calculate scores based on experience listed as required in the job description. For example, in some circumstances, up to two sets of experience required is deemed unbiased in a job description, but as additional sets of experience beyond two are added, the job becomes less desirable to females. Therefore, a coefficient may be multiplied by the number of sets of experience for the job beyond two sets.

Non-Binary Calculation Logic 245 is optionally configured to calculate scores based the ranges of years included in the experience section of the job description. The larger the range of years, the less biased the job description is against female applicants. Therefore, a coefficient may be divided by the number of years in the ranges of the experience section in the job description to adjust the bias score of the job description.

Non-Binary Calculation Logic 245 is optionally configured to calculate scores based on education listed as required in the job description. For example, in some circumstances, up to two sets of education required is deemed unbiased in a job description, but as additional sets of education beyond two are added, the job becomes less desirable to females. Therefore, a coefficient may be multiplied by the number of sets of education for the job beyond two sets.

Non-Binary Calculation Logic 245 is optionally configured to calculate scores based on the number of soft skills listed as required in the job description. For example, in some circumstances, up to two soft skills required is deemed unbiased in a job description, but as additional required soft skills beyond two are added, the job becomes less desirable to females. Therefore, a coefficient may be multiplied by the number of skills required for the job beyond two skills.

Non-Binary Calculation Logic 245 is optionally configured to calculate scores based on the number of additional requirements, beyond qualifications, technical skills, education, experience, and soft skills, listed as required in the job description. Any additional requirements for a job description is seen as less desirable to female applicants, so the score will be adjusted based on the number of additional requirements added to the job description.

Non-Binary Calculation Logic 245 is optionally configured to calculate scores based on the total number of requirements listed as required in the job description. The total number of requirements in the job description can be indicative of bias in the job description.

Non-Binary Calculation Logic 245 is optionally configured to calculate scores based on the number of male- or female-biased terms used in all components of the job description. Optionally, any male- or female-biased term may have associated with it a weight where it is given that weight as a measure of the “amount of bias” associated with that term. The weights are stored in a Word Bias Weight Repository 250 and are retrieved when needed by Non-Binary Calculation Logic 145. Word Bias Weight Repository 250 optionally includes part of Memory 120 including a data structure specifically configured to store terms and associated weights. For example, research shows that the term “ninja” has a higher occurrence of discouraging women to apply than a term like “stock option” (which also discourages women, but not at the same rate). Other examples of terms that have been shown to be more discouraging to women include “competitive”, “foosball”, “beer-o-clock”. These terms might be weighted as more problematic than other terms that are also problematic but do not discourage as many women and minorities from applying.

Non-Binary Calculation Logic 245 is optionally configured to calculate scores based on the number of terms in the job description that could be seen as biased on a non-gendered basis. Examples of terms that may be considered bias that are non-gender based include but are not limited to terms that can be construed as religious (for example, “Bless you.”), terms that could be construed as cultural (for example, “Must speak English as a first language.”), terms that could be construed as being biased against certain sexual preferences (for example, “Must lead wholesome lifestyle.”), terms that could be biased by age (for example, “only digital natives need apply”), among many others.

Non-Binary Calculation Logic 245 is optionally configured to calculate scores based on whether the author has the possibility of being biased in any way. These calculations are based on a plethora of information from the author's profile including but not limited to the author's background, ethnicity, religion, preferences, results of psychological, personality or other tests, indications from the author's co-workers or managers, etc. This information can be used to increase or decrease the bias score based on whether or not the author is likely to have a particular bias.

Job Description Management Module 200 typically includes Presentation Logic 260 configured to provide scores and or grades to an author and to allow an author to make changes or additions to their job description to influence the scores of each job description. In typical embodiments, Presentation Logic 260 may be configured to generate computing instructions (e.g., graphics, html, xml, scripts, java, or the like) configured to present an interface to an author within a browser. Alternatively, Presentation Logic 260 may be configured to present information to an author via a software agent. Part of Presentation Logic 260 is optionally disposed on Computing Device 140A.

Presentation Logic 260 is typically configured to receive inputs from an author. These inputs may include text to be included in various components of the job description, photos that will be included in the job description, commands to print a job description or groups of job descriptions, customization of an author profile, the ability to save a job description, the ability to analyze a job description, the ability to indicate that a job description is ready for review by another user, the ability to post a job description to an external location such as a jobs website, the ability to send a job description to another computing system that manages job descriptions, and/or the like. For example, in some embodiments, Presentation Logic 250 is configured to present a search field to a user through a browser. The search field is configured for a user to search for a particular job description by company, organization within the company, author of the job description, title of the job description, and/or the like.

Job Description Management Module 200 optionally includes Default Job Description Storage 255 configured to store one or more default job descriptions. Default Job Description Storage 255 can include part of Memory 120 having data structures specifically configured to store job descriptions. These default job descriptions may be associated with one or job types. For example, there may be a default job description for a User Interface Software Engineer, a default job description for a Marketing Manager, a default job description for a Customer Support Agent, etc. Default job descriptions are supplied by a corporation that has many job openings of the same type.

Default Job Description Storage 255 can optionally be configured to store the various components of one or more default job descriptions. For example, it might store several possible team descriptions that are associated with the software engineering team—one description that is written from an engineer's point of view while another description is written from a product manager's point of view. Other components that might be stored in Default Job Description Storage 255 can include company descriptions, objectives, possible qualifications, education levels, experience levels, personal skills, technical skills, etc. These default job description components may be associated with one or job types. For example, there may be a default team description for an Engineering team, a default location description for a specific corporate office, a default set of skills that can be selected for a Customer Support Agent, etc.

Job Description Management Module 200 typically includes Qualification Preference Memory 265 configured to store one or more preferences associated with the qualifications identified in a job description. In some cases this Qualification Preference Memory 265 will be associated with a job description/author pair where certain authors will have preferences of qualifications for a job descriptions that may differ from preferences of other authors.

Qualification Preference Memory 265 is optionally configured to store the order of the various priority of qualifications for the job as determined by the author writing the job description. The priorities can be specified by either creating a rank order, weighting each priority (for example a weight of 10 being the highest and a weight of 0 being the lowest), or other various means of prioritizing components within the job description. For example, if the author writing the job description specifies that the required technical skills are “Java programming” and “SQL programming”, the author may store their priority of these two skills in any appropriate manner.

Qualification Preference Memory 265 is optionally configured to store the order of the priority of responsibilities in the job description. Job Preference Memory 265 is optionally configured to store the order of the priority of technical skills in the job description. Job Preference Memory 265 is optionally configured to store the order of the priority of qualifications in the job description.

Job Preference Memory 265 is optionally configured to store the order of the priority of soft skills in the job description. Job Preference Memory 265 is optionally configured to store the order of the priority of experience in the job description. Job Preference Memory 265 is optionally configured to store the order of the priority of education in the job description. Job Preference Memory 265 is optionally configured to store the order of the priority of the various components (e.g., qualifications) of the job descriptions relative to each other. For example, the author can specify the “technical skills” are of a higher priority than “education” and so on.

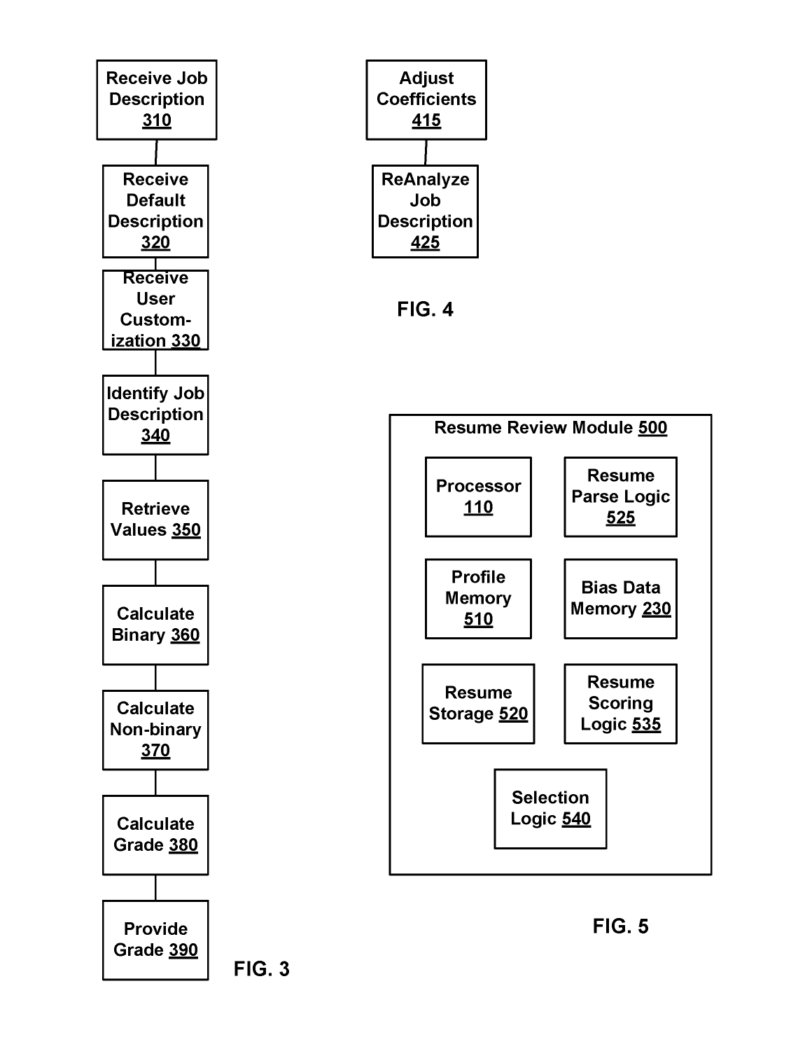

FIG. 3 is an illustration of a method of providing a grade for a job description to an author, according to various embodiments of the invention. The grade is based on various indications of potential bias in a job description as associated with the job description in question. The method illustrated in FIG. 3 is optionally performed using the Job Description Management Module 200 and can be performed in alternative step orders.

In an optional Receive Job Description Step 310 an indication of the job description to be analyzed is received by Job Description Management Module 200. This indication is optionally received via a browser or application and may include the author selecting from among a plurality of job descriptions in a menu. The received indication is optionally stored in Profile Memory 210 in association with the author.

In an optional Receive Default Job Description Step 320 one or more default job descriptions are received from Default Job Description Storage 255. The default job description is selected from among a plurality of default job descriptions stored in Default Job Description Storage 255. This selection may be based on characteristics of the job description such as the company, group within the company, title of the job, etc. As discussed elsewhere herein, the received default job description may be combined with other job descriptions, modified or enhanced, and is saved in Job Description Storage 220 as a new/altered job description.

In an optional Receive User Customization Step 330 Job Description Management Module 200 receives a customization of the default job description received in Receive Default Job Description Step 320. This customization is optionally under the approval of the author or a manager of the author. In some embodiments, the received customization may include modification of any of the qualifications or factual data associated with a particular job opportunity. The customization may be received over Network 130 from one of Computing Devices 140.

Receive Job Description Step 310, Receive Default Job Description Step 320 and/or Customization Step 330 are optional in instance where a profile for the author or a job description is already available.

In an Identify Job Description Step 340 a job description is identified. This identification may include the selection of the job description by the author from a list of job descriptions, the author providing an identifier of the job description (e.g., a job title), or the identification by Job Description Management Module 200 of job descriptions within a same category as another job description. For example, in some embodiments, Identify Job Description Step 240 includes searching Job Description Storage 220 for a job description in a specific category.

In a Retrieve Values Step 350 multiple components associated with the job description identified in Identify Job Description Step 340 are retrieved from Job Description Storage 220. This retrieval is optionally accomplished using a database query. The job description components may include the title of the job, description of the job, qualifications, requirements, and/or other information discussed herein.

In an optional Calculate Binary Step 360 a binary score for the job description identified in Identify Job Description Step 340 is calculated using Binary Calculation Logic 230. This calculation is based on the job description customized in Receive User Customization Step 330 and on one or more of the job description components retrieved in Retrieve Values Step 350. As discussed elsewhere herein, the calculation of a binary score optionally includes the use of Boolean operations.

In a Calculate Non-Binary Step 370 a non-binary score for the job description identified in Identify Job Description Step 340 is calculated using Non-Binary Calculation Logic 235. This calculation is based on the components of the job description customized in Receive User Customization Step 330 and on one or more of the job description components retrieved in Retrieve Values Step 350.

In an optional Calculate Grade Step 380 a grade is calculated from the binary score calculated in Calculate Binary Step 360 and/or the non-binary score calculated in Calculate Non-Binary Step 370. This grade is relative to a grading scale and, as such, is configured for comparison with grades calculated for other job descriptions. The calculated grade is intended to represent the amount of bias apparent in a job description. In some embodiments, the binary and non-binary scores are combined without normalization to a grade.

In a Provide Grade Step 390 the grade calculated in Calculate Grade Step 390, the binary score calculated in Calculate Binary Step 360, the non-binary score calculated in Calculate Non-Binary Step 370, and/or a combination thereof is provided to the author. This information is provided using Presentation Logic 250 and is optionally provided via Network 130 to one or more of Computing Devices 140. For example, the information may be displayed on a browser within Computing Device 140A. In some embodiments, grades or scores for multiple job descriptions are displayed together for comparison by the author. In other embodiments, a time series of grades for one or more job descriptions is displayed for the author so that the author can see the change in biases in one or more job descriptions as changes were made over time.

FIG. 4 is an illustration of a method of comparing job descriptions, according to various embodiments of the invention. In this method grades for several job descriptions are calculated and provided to an author for comparison. Also, multiple grades for the same job description can be displayed in a time-series for comparison by the author. For example, if a job description received a grade of “C” on January 1 and was modified on January 2 and then received a grade of “B”, a time-series chart could show the author the change to the score of the job description as changes were made. The methods illustrated by FIG. 4 are optionally performed using Job Description Management Module 200. The steps illustrated in FIG. 4 may be performed in either order.

In an optional Adjust Coefficients Step 415 coefficients used by Bias Scoring Logic 235 are adjusted based on the tolerance for various types of biases. As a result, scores for all of the job descriptions associated with those coefficients may change based on a change to the coefficients. In this embodiments, a ReAnalyze Job Description Step 425 can be run to re-analyze the job descriptions in the class for which the coefficients have been adjusted. These two steps may be performed recursively.

In ReAnalyze Job Description Step 425 being run, the previous grades of the job descriptions are stored and an additional value is stored in the Job Description Storage 220 to indicate that a change was made to the coefficients prior to this running of the grading of the job description.

Thus, in FIG. 4 when job description grades are displayed, an indication is shown to the author through the Job Description Management Module 200 that there was a change to the coefficients prior to obtaining the displayed grade.

FIG. 5 is a block diagram illustrating further details of Resume Review Module 500, according to various embodiments of the invention. Resume Review Module 500 may include a personal computer, a server, a web server, a file server, a distributed computing system connected by a network, a communication device, and/or the like. In some embodiments, Resume Review Module 500 is configured to be accessed over Network 130, for example, using Computing Devices 140. Resume Review Module 500 comprises at least one Processor 110 and Profile Memory 510 configured to store a reviewer's profile (the term “reviewer” is used to refer to the human reviewer(s) of the resume or set of resumes). Processor 110 and Profile Memory 510 are optionally shared with Job Description Management Module 200. Profile Memory 510 may include part of Memory 120 and specific data structures configured to store a user's profile. For example, Profile Memory 510 is optionally configured to store a database of profiles associated with a plurality of reviewers. The reviewer profiles include reviewer identification information such as a reviewer login name, a reviewer's name, an identification number, an account name, a password, and/or the like.

The reviewer profiles further include professional and/or personal information regarding the reviewer. This professional and/or personal information can include, but is not limited to the person's job title, the name of the company in which the person is employed, the name of the organization within the company in which the person is employed, the name and identification number of the person's immediate supervisor, the person's gender, the person's birth date, the date of employment for this person at this company, information identifying the person's previous employment history, information identifying the person's education, information about the person's employment performance at this organization, results of various psychological, personality, and other tests completed by the person, feedback or other reviews by colleagues of the person, the person's race and other information that may identify any biases that may arise from this person. One or more of the tests completed by the person are typically configured to identify biases of that person. In addition, results of past reviews by the person can be used to analyze whether or not the person is biased. For example, if the person tends to score a resume that includes “Harvard” in the education section of the resume higher than resumes that don't include the word “Harvard”, this could indicate a bias on the side of the reviewer.

The information may have been entered into the Profile Memory 510 when it was provided by the person or by the person's supervisor via a browser. The information may have been entered into the Profile Memory 210 by another process. For example, Data Upload Logic 215 is optionally configured to upload the data associated with one or more reviewer profiles into the Profile Memory 510.

For example, the reviewer profile may include information that the reviewer was born on Jan. 1, 1971, is female, has been employed with the Acme Corporation since Jan. 1, 2003 and held the title of Director of Engineering from Jan. 1, 2003 to Jan. 1, 2005, the title of Sr. Director of Engineering from Jan. 1, 2005 to Jul. 31, 2009, and Vice President of Engineering from Aug. 1, 2009 to the present. Additionally, the Profile Memory 510 can optionally contain information about the reviewer that would indicate potential bias by the reviewer. Example information that could indicate the reviewer's bias includes, but is not limited to, where the reviewer went to school, the ethnicity of the reviewer, any religious affiliations of the reviewer, any cultural or athletic affiliations of the reviewer, indication of the reviewer's socio-economic background, results of personality, psychological, or other tests that might indicate various types of biases, feedback from co-workers and managers, etc.

Resume Review Module 500 further includes a Resume Storage 520 configured to store a set of one or more resumes. Resume Storage 520 may include part of Memory 120 having a data structure specifically configured to store resumes. Resume Storage 520 is optionally configured to store a database of resumes associated with a plurality of job candidates. The resume profiles include resume identification information which may include, but is not limited to, the name of the candidate, the address of the candidate, the phone number of the candidate, the email address of the candidate, information about the work experience of the candidate, information about the education of the candidate, a list of skills of the candidate, and/or the like.

Resume Review Module 500 is configured for displaying the components of the resumes to the reviewer. Presentation of resumes is optionally interleaved. For example, if the reviewer needs to review 10 resumes and each resume has 6 components (experience, education, hard skills, soft skills, certifications, and interests), the Resume Review Module 500 will show each of the experience components of all 10 resumes and then show each of the education components, and after that each of the hard skills components, etc. The presentation of components from different resumes is performed in groups by component type. This process of presenting one component group at a time is referred to herein as viewing the resumes in parallel. The order of components is optionally based on the priority of the components as indicated by the reviewer. For example, if the reviewer indicated that experience is the most important component of a resume for a job, the reviewer will be shown 10 experience components as a group, without other associated components. The 10 experience components (from the 10 resumes) will be shown in random order and when the next set of components is shown (e.g., education), that set will be shown in an optionally different order. The orders are undisclosed to the reviewer. This process prevents the reviewer from associating a particular experience component with an associated education component and so on, removing the likelihood that the reviewer could see something in experience that could influence the way they view someone's education. This reduces some sources of bias in reviewing resumes.

The resume components may have been entered into the Resume Storage 520 when it was provided by the candidate via a browser. Alternately, it may have been entered into the Resume Storage 520 by another person, for example, a recruiter or a hiring manager. Alternately, it may have been entered into the Resume Storage 520 by another process. Alternatively, a substitute for the resume may be used such as a LinkedIn profile. In this case, the candidate would likely supply the Universal Resource Locator (URL) associated with the public version of their LinkedIn profile. For example the Data Upload Logic 115, is optionally further configured to upload the data associated with one or more resumes into the Resume Storage 520. Resumes are optionally stored in Resume Storage 520 in a parsed format—either through data structures or meta tags—such that the various components of the resume (like experience, education, etc.) are separate from each other but still linked to an overarching resume.

Resume Parse Logic 525, is optionally configured to parse an electronic version of a resume into its various components. Resume Parse Logic 525, will evaluate an electronic version of a resume and determine which text elements correspond to, for example, the name of the candidate, the address of the candidate, the work experience of the candidate, the education of the candidate, etc. In the case that Resume Parse Logic 525 identifies some text in the resume that cannot be categorized into a particular resume component, Resume Parse Logic 525 will request that the text be classified by a human. The possible humans that could classify the text include, but is not limited to, the candidate, the recruiter, the hiring manager, or some other person who is asked to classify the text of resumes into the various resume components. Any text that cannot be classified into a component of the resume will not be used for scoring in this process. The results of Resume Parse Logic 525 are stored in Resume Storage 520.

Resumes stored in Resume Storage 520 are optionally grouped in resume “families.” Resume families may include resumes for candidates applying for the same job, resumes for candidates applying in the same timeframe, resumes of candidates in the same geographic region, etc.

Resume Review Module 500 further includes Bias Data Memory 230, which may be shared with Job Description Management Module 200. Further examples of things that can be stored in Bias Data Memory 130 include, but are not limited to various first and last names that may indicate ethnicity, names of student and professional organizations that may indicate ethnicity (e.g., “President of the Black Students of America Group”), legal/criminal records, educational institutions that might make a reviewer favor or discard a candidate, military service record, etc.

The Bias Data Memory 230 optionally contains mitigation techniques for removing bias from the process of reviewing a resume. Examples of mitigation techniques include but are not limited to noting when the reviewer and the candidate attended the same school, noting when the reviewer is also the person who referred the candidate for the job, bias indicated by tests based on previous resume reviews by the reviewer, etc. An example of a test based on previous resume reviews by the reviewer include testing the resumes selected for interview by the reviewer compared with those not selected. Demographic information from each set of resumes (for example, gender, ethnicity, military veteran status, age, etc.) can be tested to show whether the reviewer appears to have preferences for a particular demographic group.

Resume Review Module 500 further includes Resume Scoring Logic 535 configured to calculate a score that is the indication of how well the candidate associated with the resume will perform in the job to which the candidate is applying. In some embodiments, Resume Scoring Logic 535 includes computer code configured to present a web interface to a user within a browser. In some embodiments, Resume Scoring Logic 535 includes computer code configured to present an interface to a person through their cellular telephone or other telecommunication device. In this case there is often an application that part of Resume Review Module 500 and is configured to be used on the phone or other communication device.

Example calculations that can be performed by the Resume Scoring Logic 535 include, but are not limited to, the reviewer-defined weighting of a particular component of the resume multiplied by a score given by the reviewer as to the candidate's likelihood to succeed in the position given the contents of the component of the resume, the summing of all of the weighted scores of the different components of the resume, the averaging of all of the scores given to components, the mean of all of the scores given to components, etc. As an example, consider that a resume reviewer gave the following indications of weight to the components of a resume where the first part is the resume component and the number in parentheses is the resume reviewer's weight: experience (10), technical skills (8), soft skills (5), education (5), and person who referred the candidate (4). And for a particular resume, the reviewer gave the text in the component of the resume the following scores: experience (3), technical skills (10), soft skills (4), education (9), the person who referred the candidate (9). Then one possible way to compute the score for this particular resume according to this reviewer is to multiply the weights by the scores. Namely, the overall score for the resume would be (10×3)+(8×10)+(5×4)+(5×9)+(4×9)=30+80+20+45+36=211. Other resumes would then be scored and this final, weighted score would be computed. These weighted scores can be used to compare a set of resumes against each other. Optionally, the score can be normalized, for example to fall in the range of 1 to 100.

An additional example uses the potential biases of the reviewer to increase or decrease the score of the resume based on some component of the resume. For example, if the reviewer has a degree from Harvard, a resume where the candidate has a degree from Harvard may have its score reduced to account for the fact that the reviewer may be biased towards the graduates of Harvard.

When a reviewer begins the process of reviewing resumes, the reviewer is optionally prompted by the Resume Review Module 500 to indicate the order of importance of the components of a resume in determining whether or not a candidate will be successful in performing the job to which the candidate is applying. For example, for a particular job the experience of the job candidate may be the most indicative of whether or not the candidate will perform well in the job. For another job, the certifications achieved by the candidate may be most indicative of how well the candidate will perform in the job. The importance of the components of the resume is determined by the reviewer when that person thinks about the qualifications of a successful candidate in the particular job. In some cases this can be determined when the reviewer or author is creating the job description for the job, but it can also be determined at the time of the resume review or at other times.

Resume Review Module 500 is optionally configured to have a reviewer either manually score the various components of the resume—for example, on a scale of one to 10, having the scores of all of the components sum to a normalized value of 100, etc.—or the reviewer will put the components of the resume in order of how much the various components indicate the of likelihood of good performance of the candidate on the job. The scores, weights, or rankings associated with the components of the resume are optionally stored in Resume Storage 520.

In an optional embodiment, these rankings can be associated with the competencies identified during the creation of the job description. Resume Review Module 500 can be configured to either allow the reviewer to change the ranking of the competencies or can enforce that the rankings not be changed, depending on the scenario desired by the company.

Prompting the reviewer to rank, weight, or score the components of the resume means the reviewer is “pre-committing” to what is important for the job. Various biases have been known to come into play when a reviewer looks at a particular resume, sees the text associated with the candidate in the component of the resume and then decides, either consciously or unconsciously, that the particular component of the resume is most important to the job. By having a reviewer “pre-commit” to which resume components are most important to the job prior to the review of any resumes, it has been shown that some bias can be removed. For example, if the reviewer believes that the person who fills the job should be male, the reviewer might look for something impressive on the male candidate's resume and use that to indicate why the male is better qualified for the job. By having the reviewer “pre-commit” to what is important for the job, it has been shown that the reviewer is more likely to choose a candidate that has the best credentials for the area that was pre-committed as most important.

Once the reviewer has pre-committed to the priority of the resume components, the reviewer will be asked to rank, weight, or prioritize the text associated with these resume components. First the reviewer will be shown the text associated with the highest priority component for all of the resumes. For example, if the reviewer has seven resumes to review and has specified that “experience” is the highest priority component of the resume to determine future job success, the reviewer will be shown seven text boxes that show the text for “experience” in each of the seven resumes. The reviewer may not be shown any other components of the resume at this time. After that, the reviewer will be shown seven sets of “education” (or whichever component of the resume was said to be second most important during the pre-commitment phase). The order of the components of the resume will be randomized such that the first resume component for “experience” may correspond to a different resume than the first resume component shown for “education”.

By showing the text associated with only one component of a resume at a time, the reviewer is not able to have one part of a resume bias what the reviewer sees in another part of a resume. The usual example of this is when a name may indicate gender or race, but another place where this bias can come into play is education. Some reviewers are biased towards hiring people from Ivy League universities. These reviewers may inflate their view of candidates from these universities and/or decrease their view of resumes for candidates who did not attend Ivy League universities. By only showing one resume component at a time, reviewers are not able to allow their biases about other components of a resume influence their view of the overall resume.

Resume Review Module 500 may have the reviewer either score the various text boxes—for example, on a scale of one to 10, etc.—or the reviewer may put the text boxes from the resumes in order of how much the various components indicate the of likelihood of good performance of the candidate on the job, or the like.

The scores, weights, or rankings associated with the text of each one of the components of the resumes is optionally stored in Resume Storage 520.

In some embodiments, once the reviewer has scored or ordered the text boxes for the highest priority component of the resumes, the reviewer is shown the text of the second most important component of the resumes, and so on until all of the components of the resumes have been viewed and scored/ranked by the reviewer. The scores, weights, or rankings associated with the text of one of the components of the resumes are stored in Resume Storage 520.

In the case that some resumes have no text associated with a particular resume component, Resume Review Module 500 will display that some resumes did not include that component. For example, if two of the seven resumes being reviewed did not include any text for “Interests”, when the Resume Review Module 500 displays the text associated with “Interests”, it will include text similar to the following: “Two resumes did not include any text for ‘Interests’.”

While the reviewer is looking at particular components of the resumes, Resume Review Module 500 may or may not remind the reviewer of the predefined priority of the resume component. For example, if the reviewer specified that “Experience” is most important for success in the job in question, when the reviewer is looking at success Resume Review Module 500 may or may not have text similar to “As a reminder, you (or an author that defined the relevant job description) said that Experience was the most important component of the resume to indicating future job success.”.

Resume Scoring Logic 535 uses a calculation of the ranking score for each resume based on the information stored in the Bias Data Memory 130. In various embodiments, there are a wide variety of methods by which Resume Scoring Logic 535 can be calculated. In some embodiments Resume Scoring Logic 535 is an equation (e.g., a linear equation) that includes the sum of the priority of the various components of the resume multiplied by the score given to the particular text for the component of the resume for each component in the resume. In other embodiments of Resume Scoring Logic 535 uses other linear and non-linear equations that uses the priority or score associated with each resume component and the score or ranking associated with the text within the resume component to determine an overall score for each resume. Resume Scoring Logic 535 optionally includes binary and non-binary calculation logic such as that discussed elsewhere herein.

Optionally, once Resume Scoring Logic 535 has been used to score several or every resume in a group, Resume Review Module 500 is configured to display all of the full resumes to the reviewer in rank order using the rank determined by Resume Scoring Logic 535.

At this point, Resume Review Module 500 is configured to prompt the reviewer to categorize each resume. Possible categories of resumes include, but are not limited to: save for later, discard (archive), move to interview process, move to phone screen, move to reference check, and others. The purpose of the categorization of the resume is to determine next steps. In some cases it will be expected that there will be additional resumes to review at a future time, so some resumes may be saved for comparison with resumes that are added to the system later. When a resume is reviewed and then saved for comparison with future resumes the reviewer could either be prompted for whether they want to review the resume again in a new set of resumes or whether they just want to compare the score/ranking of the previously reviewed resume with the score/rankings of the new set of resumes.

Resume Review Module 500 optionally further includes Selection Logic 540 configured for selecting a reviewer to review one or more resumes. Selection Logic 540 is configured to select reviewers based on reviewer profiles stored in Profile memory 510 and is typically configured to select reviewers so as to minimize bias in the review. For example, a reviewer known to have a bias against candidates from certain countries would not be assigned to review resume components that are likely to indicate a country of origin. Likewise, a reviewer known to have a bias against certain schools would be avoided for the review of the Educational component of a resume.

Selection Logic 540 is optionally configured to assist a human manager in selection of a review team. For example, Selection Logic 540 may provide a list of possible reviewers ranked by the amount of bias they are likely to contribute to the review process. Such ranking may differ for different components and a reviewer may be selected to review all of a resume or one or more specific components.

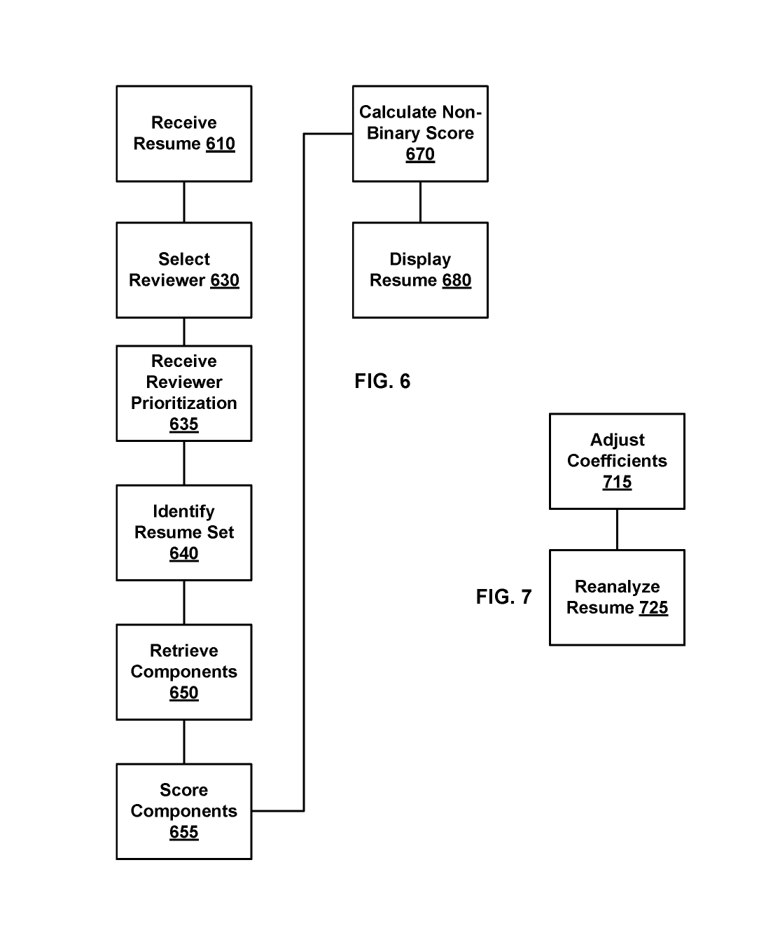

FIG. 6 is an illustration of a method of providing a set of resumes to a reviewer, according to various embodiments of the invention. In a Receive Resume Step 610 an indication of the resume to be analyzed is received by Resume Review Module 500. This indication is optionally received via a browser or application and may include the reviewer selecting from among a plurality of jobs for which they want to review resumes. The received indication is stored in Profile Memory 210 in association with a candidate and a particular job or set of jobs. Receive Resume Step 610 is optional in instances where a resume is already available.

In an optional Select Reviewer Step 630, one or more human reviewers are selected to review the resume. Reviewers may be selected to review an entire resume or one or more components thereof. For example, one reviewer may be selected to review an education component and another reviewer selected to review a technical experience component. The selection of reviewers is optionally made in consideration of any known biases of the reviewers. For example, a reviewer known to be biased against certain schools may be assigned a component other than education to review. Select Reviewer Step 630 is optionally performed using Selection Logic 540.

In an optional Receive Reviewer Prioritization Step 635, Resume Review Module 500 receives a prioritization, set of scores, or set of weights from the reviewer or a set of reviewers of the components that can be included in a resume. The prioritization may be received over Network 130 from Computing Device 140A.

In an Identify Resume Set Step 640 a set of resumes, usually associated with a particular job opening, is identified. This identification may include the selection of the set of resumes by the reviewer from a list of resumes, the reviewer providing an identifier of a job description (e.g., a job title), or the identification by Resume Review Module 500 of a set of resumes within a same category as another set of resumes. For example, in some embodiments, Identify Resume Step 640 includes searching Resume Storage 520 for a set of resumes in a specific category.

In a Retrieve Components Step 650 multiple components associated with the resume identified in Identify Resume Step 640 are retrieved from Resume Storage 520. This retrieval is optionally accomplished using a database query. The resume components may include the title of the job, description of the job, qualifications, requirements, scores associated with the text components of a particular resume, and other information discussed herein.

In a Score Components Step 655 the reviewer scores the components of the resume presented to him or her. This can be accomplished by giving them numerical scores, giving them some kind of score on a continuum (perfect for the job to not relevant to the job), ranking them in order of most qualified for the job to least qualified for the job, etc. The scoring may be facilitated by a graphically user interface generated by Resume Scoring Logic 535.

In a Calculate Score Step 670 a non-binary score for the resume identified in Identify Resume Step 640 is calculated using Resume Scoring Logic 535. This calculation is based on the components of the resume customized in Identify Resume Step 640, on one or more of the scores associated with the resume components retrieved in Retrieve Components Step 650, and on the prioritization scores or weighting identified in Receive Reviewer Prioritization Step 635.

Calculate Score Step 670 may also allow for the possibility of multiple reviewers. In the case of multiple reviewers the final score for the resume may be determined by adding the scores of the reviews of the same resume together or using some other coefficient or multiplier to get a combined score for the resume based on the scores by each reviewer for that resume.

In a Display Resume Set Step 680 the score calculated in Calculate Non-Binary Score Step 670 for each resume in the set is used to display the set of resumes to the reviewer. The text associated with each resume is displayed and the resumes are displayed in rank order as indicated by the scores calculated in Calculate Non-Binary Score Step 670. This information is provided using Presentation Logic 260 (or similar logic) and is optionally provided via Network 130 to one or more of Computing Devices 140. For example, the information may be displayed on a browser within Computing Device 140C. In some embodiments, multiple sets of resumes are shown at the same time to the reviewer. In other embodiments, a time series of scores for one or more resumes is displayed for the reviewer so that the reviewer can see the change in scores in one or more resumes as changes were made to the prioritization of components or the scores associated with the text of components of the resume or resumes over time.

In the case that multiple reviewers review the same set of resumes, Display Resume Set Step 680 allows the reviewer to see the resumes in order depending on which order is preferred. For example, the reviewer may prefer to see the resumes in order of the scores given by only that reviewer's scores. Alternatively, the reviewer may want to see the resumes in order of the scores of another reviewer. Alternatively, the reviewer may want to see the resumes in order of the combined scores of all of the reviewers or based on scores of a particular resume component. The reviewer will specify to Display Resume Set Step 680 which scores should be used when displaying the resumes.

FIG. 7 is an illustration of a method of comparing resumes, according to various embodiments of the invention. In this method the scores for several resumes are calculated and provided to a reviewer, alongside the full text of the resumes for comparison. Also, multiple scores for the same resume can be displayed in a time-series for comparison by the reviewer. For example, if a resume received a score of “70” on January 1 and either the prioritization of resume components or the scores/ranking of the text associated with some set of components of the resume was modified on January 2 and the resume then received a score of “78”, a time-series chart could show the reviewer the change to the score of the resume as changes were made. Time series of scores associated with a set of resumes can optionally be displayed. The methods illustrated by FIG. 3 are optionally performed using Resume Review Module 500. The steps illustrated in FIG. 3 may be performed in either order.

In an optional Adjust Coefficients Step 715 coefficients used by Resume Scoring Logic 535 are adjusted based on the tolerance for various types of biases. As a result, scores for all of the resumes associated with those coefficients may change based on a change to the coefficients. For example, if it is known that the reviewer gives more weight to resumes that include the word “Harvard”, the weight for the Education component of the resume may be reduced for that reviewer. Either separately or in addition to this adjusting of the weights, a text search could be performed on all resumes and those that contain the word “Harvard” could have their scores adjusted to account for the possible bias of the reviewer. As a contrasting example, if a reviewer is known to be biased against women, the scores for all resumes for women could be increased. In this embodiment, a ReAnalyze Resume Step 725 can be run to re-analyze the resumes in the class for which the coefficients have been adjusted.

In the case of the ReAnalyze Resume Step 725 being run, the previous scores of the resumes are optionally stored and an additional value is stored in the Resume Storage 520 to indicate that a change was made to the coefficients prior to this running of the grading of the resume. Thus, in FIG. 7 when resume scores are displayed, an indication is optionally shown to the reviewer through the Resume Review Module 500 that there was a change to the coefficients prior to obtaining the displayed score.

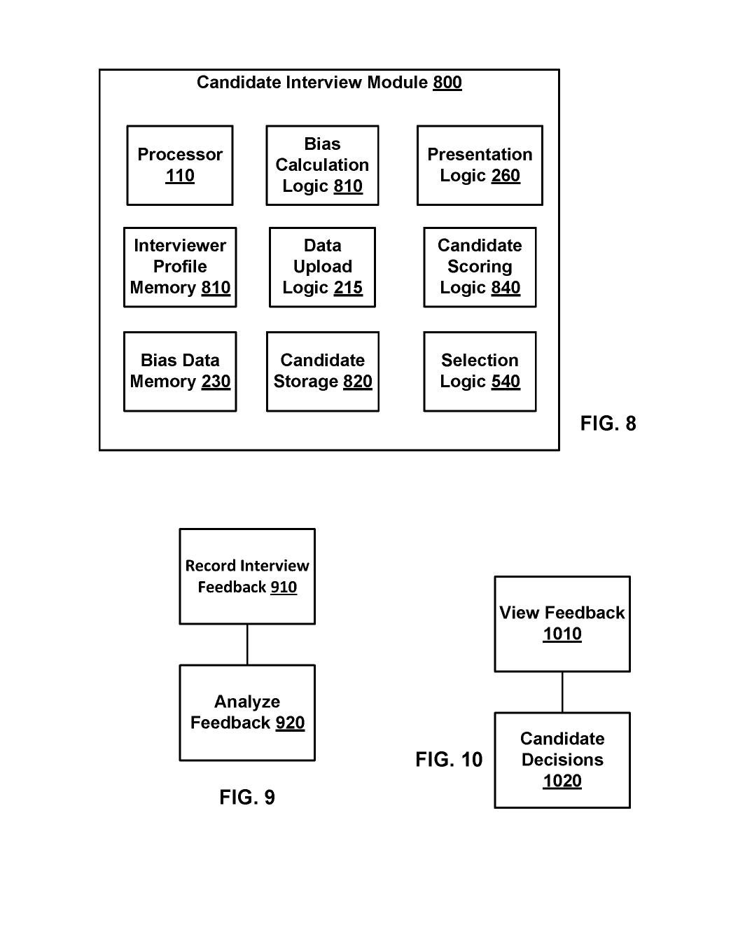

FIG. 8 is a block diagram of Candidate Interview Module 800, according to various embodiments of the invention. Candidate Interview Module 800 is, for example, a tool that can be used for conducting interviews, phone screens, reference checking, and/or the like. In some embodiments, Candidate Interview Module 800 is configured to be accessed over Network 130 using Computing Devices 140. Candidate Interview Module 800 optionally includes Processor 110 and/or logic used to program Processor 110 to perform specific tasks. Processor 110 is optionally shared with Job Description Management Module 200 and/or Resume Review Module 500.

Candidate Interview Module 800 includes an Interviewer Profile Memory 810 configured to store a set of characteristics of the interviewers of candidates. The term interviewer is used to refer to the human interviewer(s) of the candidate or set of candidates. Interviewer Profile Memory 810 is optionally configured to store a database of profiles associated with a plurality of interviewers. The interviewer profiles include interviewer identification information such as an interviewer login name, an interviewer's name, an identification number, an account name, a password, and/or the like. Interviewer Profile Memory 810 optionally includes part of Memory 120 including data structures specifically configured to store interview profiles.

The interviewer profiles further include professional and/or personal information regarding the interviewer. This professional and/or personal information can include, but is not limited to the person's job title, the name of the company in which the person is employed, the name of the organization within the company in which the person is employed, the name and identification number of the person's immediate supervisor, the person's gender, the person's birth date, the date of employment for this person at this company, information identifying the person's previous employment history, information identifying the person's education (e.g., schools attended and/or degrees earned), information about the person's employment performance at this organization, results of various psychological, personality, and other tests completed by the person, feedback or other reviews by colleagues of the person, the person's race, place of birth, citizenship and/or cultural heritage, and any other information that may identify any biases that may arise from this person. One or more of the tests completed by the person are typically configured to identify biases of that person. In addition, results of past interviews conducted by the person can be used to analyze whether or not the person is biased. For example, if the person tends to score a candidate that attended Harvard higher than candidates that didn't attend Harvard, this could indicate a bias on the part of the interviewer.

The information about an interviewer may have been entered into Interviewer Profile Memory 810 when it was provided by the person or by the person's supervisor via a browser. Optionally, this information may be garnered from tests taken by the interviewer to determine various types of bias the interviewer may have. The information may have been entered into Interviewer Profile Memory 810 by another process. For example, Data Upload Logic 215 is optionally configured to upload the data associated with one or more interviewer profiles into Interviewer Profile Memory 810.

The interviewer profile may include information that the interviewer was born on Jan. 1, 1971, is female, has been employed with the Acme Corporation since Jan. 1, 2003 and held the title of Director of Engineering from Jan. 1, 2003 to Jan. 1, 2005, the title of Sr. Director of Engineering from Jan. 1, 2005 to Jul. 31, 2009, and Vice President of Engineering from Aug. 1, 2009 to the present. Additionally, Interviewer Profile Memory 810 can optionally contain information about the interviewer that would indicate potential bias by the interviewer. Example information that could indicate the interviewer's bias includes, but is not limited to, where the interviewer went to school, the ethnicity of the interviewer, any religious affiliations of the interviewer, any cultural or athletic affiliations of the interviewer, indication of the interviewer's socio-economic background, results of personality, psychological, or other tests that might indicate various types of biases, feedback from co-workers and managers, etc.

Candidate Interview Module 800 further includes a Candidate Storage 820 configured to store a set of profiles of one or more candidates associated with a set of job openings. Candidate Storage 820 may include part of Memory 120 having a data structure specifically configured to store candidate profiles. The candidate profiles include candidate identification information such as the candidate's name, an identification number, physical address, email address, phone number, and/or the like. Additionally, the candidate profiles include resume information for the candidate including, but not limited to, information about the candidate's experience, education, skills, certification and/or the like.

Additionally, candidate profiles can include demographic and other information such as gender, race, nationality, sexual preference, veteran status, handicap status, and/or other information, which may induce biases from interviewers. Additionally, candidate profiles can include results of various psychological, personality, and other tests completed by the candidate.

Candidate Storage 820 is optionally configured to store a database of resumes associated with a plurality of job candidates. The resume profiles include resume identification information which may include, but is not limited to, the name of the candidate, the address of the candidate, the phone number of the candidate, the email address of the candidate, information about the work experience of the candidate, information about the education of the candidate, a list of skills of the candidate, and/or the like. Optionally, resume scores for one or more specific job opportunity is stored as part of a candidate profile.

The information about a candidate may have been entered into the Candidate Storage 820 when it was provided by the candidate by inputting their resume or portions of their resume via a browser or when it was received by a recruiter or hiring manager via a browser. The information may have been entered into the Candidate Storage 120 by another process. For example, Data Upload Logic 215 is optionally configured to upload the data associated with one or more candidate profiles into the Candidate Storage 820. This data may be parsed from resumes.

Candidate Interview Module 800 further includes Bias Data Memory 230 configured to store information about various forms of biases, various indicators of those biases, various techniques for mitigating those biases and various descriptions of the biases, and/or the reasoning behind the biases and the mechanisms for mitigating the biases in interviews. Further examples of things that can be stored in the Bias Data Memory 230 include terms that are often used to indicate that female candidates are not acceptable for a job and similar terms. Bias Data Memory 230 is optionally shared with Job Description Management Module 200 and/or Resume Review Module 500.

The Bias Data Memory 230 optionally contains mitigation techniques for removing bias from the processes of conducting interviews, performing phone screens, and checking references. Examples of mitigation techniques include but are not limited to noting when the interviewer and the candidate attended the same school, noting when the interviewer is also the person who referred the candidate for the job, bias indicated by tests based on previous interviews by the interviewer, an indication that an interviewer didn't spend enough time on particular questions with the candidate, terms in the interview feedback like “not a culture fit” or other problematic text, etc.

Candidate Interview Module 800 is configured to display a set of candidates being considered for a particular job opening. A hiring manager (e.g., the person ultimately responsible for making the hiring decision about a particular job opening) can view the set of candidates and determine the next step for determining which candidate is the best fit for the job opening. Possible next steps include, but are not limited to: conducting an onsite interview, conducting a phone screen, or conducting reference checks. The hiring manager indicates to Candidate Interview Module 800 which next step the hiring manager wants to take for a particular job opening and, at that point, Candidate Interview Module 800 walks the hiring manager through the steps to perform the specified function.

The steps that may be performed using Candidate Interview Module 800, for interviewing, phone screens, and reference checking are similar. For example, in some embodiments, when a hiring manager indicates that he or she wants to conduct an onsite interview, Candidate Interview Module 800 prompts the hiring manager to select the set of one or more candidates to be interviewed. In addition, Candidate Interview Module 800 prompts the hiring manager to indicate the interviewers to be included in interviewing the selected set of candidates.

Candidate Interview Module 800 is optionally configured to prompt the hiring manager to determine the set of questions to be asked of each candidate. Research indicates that the best types of questions to ask candidates are behavior-based questions or performance-based questions. Candidate Interview Module 800 provides a set of behavior-based interview questions and/or a set of performance-based interview questions to the hiring manager so that the hiring manager can select which of these questions he or she wants the interviewers to ask the candidates. The questions presented to the hiring manager can, but do not have to, be based on any of the following: the competencies specified at the time the job description was written, the information in the job description, information recorded about priorities of qualifications or other items in the job description, information about which qualifications were indicated as most important in the resume review process, scores of resumes of candidates in the resume review process (including, but not limited to, specific qualifications on particular resumes that received low scores in the resume review process), information provided by the candidate via the resume, feedback recorded during a phone screen interview, etc.

The questions presented to the hiring manager can, but do not have to be, reviewed by someone in human resources or the legal team to determine whether or not they are in compliance with appropriate laws, policies of the company, branding associated with the company, identification of questions that may be biased (for example, “do you plan to have children soon?”), etc.

In addition, the hiring manager can enter their own questions they want the interviewers to ask the candidates. In the case that hiring managers enter their own questions, Bias Calculation Logic 810 can be used to determine if any of the questions entered by the hiring manager contain indications of bias. Possible indications of bias could include, but are not limited to, asking about sports, asking about specific schools or educational background, asking questions related to anything that was indicated as a specific bias of the interviewer in the Profile Memory 210. In the case that bias is suspected, several possible actions can be taken. These actions include, but are not limited to notifying the hiring manager that the question may be biased, recommending to the hiring manager that the biased question be changed, recording that a biased question has been included, notifying a supervisor, recruiter or other individual that a biased question has been included, and/or not allowing the hiring manager to use that question as part of the Candidate Interview Module 800. In addition, Bias Calculation Logic 810 can optionally suggest to the hiring manager particular questions for particular interviewers based on any bias indicated for an interviewer. For example, if it is known that a particular interviewer prefers candidates that completed their education degrees from Harvard, Bias Calculation Logic 810 could indicate to the hiring manager that the particular interviewer should not ask the candidates about their educational backgrounds.

In some embodiments, the hiring manager may assign a “competency” for the interviewer to explore. These competencies are skills or qualifications that are important for the job. Examples of competencies include, but are not limited to, “Java skills”, “ability to build teams”, “good rapport with customers”, etc. Interviewers are then tasked with determining the proficiency of the candidate in these competencies, but are free to determine the best way to assess the competency for the candidate.

Once the set of candidates has been identified, the interviewers have been identified, and the set of questions to be used during the interview have been identified, Candidate Interview Module 800 prompts the hiring manager to assign a set of interview questions to each interviewer. Each of the questions that have been identified for use during the interview will be assigned to one or more interviewer to be asked. In some embodiments, to avoid the possibility of bias, each interviewer asks the same set of questions to each candidate. For example, Interviewer A will ask all candidates Questions 1A, 2A, and 3A as assigned by the hiring manager and Interviewer B will ask all candidates Questions 1B and 2B as assigned by the hiring manager. If Interviewer A asks Candidate 1 about Question 1A and records a response, then having Interviewer B ask Candidate 2 about Question 1A and recording the result may create a discrepancy between the quality of responses to Question 1A. By ensuring that the same interviewer asks the same questions and records responses it is more likely that there will be consistency across the way candidates are judged. Alternatively, interviewers can be assigned competencies to evaluate instead of specific questions. Alternatively, interviewers can be assigned a combination of interview questions and competencies.

The candidate identification step, interviewer identification step, and question determination step can be carried out in any order.

Once the questions have been assigned to each interviewer, Candidate Interview Module 800 prompts the hiring manager to schedule the interviews for each candidate. Assistance in scheduling the interviews can be accomplished through the Candidate Interview Module 800 or through some other tool such as Microsoft Outlook™ or another tool.

Optionally, once the interviews have been scheduled, Candidate Interview Module 800 records the date and time for each interview. At some point before the interview occurs, Candidate Interview Module 800 can notify the interviewer of the upcoming interview and provide information that explains the questions to be asked by the interviewer of each candidate. Alternatively, the hiring manager can be provided a Universal Resource Locator that takes the interviewer to a webpage that explains the process of the interview. The Universal Resource Locator can be included in a calendar invite for the interviewer for convenient access. The web page where the interviewer receives information about the interview may or may not be password protected. An electronic or paper template can be provided to each interviewer that facilitates the interviewer conducting the interview in the way specified by the hiring manager. This template could include, but is not limited to, a script for explaining to the candidate how the interview will progress, suggested interview questions, the resume of the candidate, prose from the hiring manager of specific things to look for in the candidate, the date and time of the interview, recommendations for how to conduct an unbiased interview, information about biases that are known for the interviewer to make him or her aware of his or her biases, etc.

A similar process to the one described for coordinating interviews is carried out when a hiring manager wants to perform a phone screen or a set of phone screens. In the case of a phone screen Candidate Interview Module 800 prompts the hiring manager to select the set of candidates to be screened, determine the person or set of people who will perform the phone screen and establish the set of questions to be used by those people during the phone screen. Questions used for phone screens should also be either behavior-based or performance-based or meant to assess competencies. Once the phone screen has been scheduled, Candidate Interview Module 800 notifies the people performing the phone screen as to the format of the phone screen similar to the way Candidate Interview Module 800 notified interviewers of the format of the interview prior to the date and time of the interview. Alternatively, electronic calendar invitations can be created and a Universal Resource Locator can be put into such calendar invitations. Creating consistency across phone screens helps to mitigate the impact of biases in the same way it for candidate interviews.

A similar process to the one described for coordinating interviews is carried out when a hiring manager wants to perform a reference check or a set of reference checks. In the case of reference checks Candidate Interview Module 800 prompts the hiring manager to select the set of candidates to be checked, determine the person or set of people who will perform the reference check and establish the set of questions to be used by those people during the reference check. Questions used for reference checks should also be either behavior-based or performance based checking the behavior or the performance of the candidate or meant to assess competencies. The questions suggested and/or chosen to be asked could correspond to the type of reference to be checked. For example, there may be a set of questions that are appropriate to be asked of a former employer and another set of questions that are appropriate to be asked of a teacher, etc. Once the reference check has been scheduled, Candidate Interview Module 800 notifies the people performing the reference check as to the format of the reference check similar to the way Candidate Interview Module 800 notified interviewers of the format of the interview prior to the date and time of the interview. Alternatively, electronic calendar invitations can be created and a Universal Resource Locator can be put into such calendar invitations. Creating consistency across phone screens helps to mitigate the impact of biases in the same way it does for candidate interviews.

FIG. 9 is an illustration of a method of providing feedback on a candidate based on a job interview, phone screen or reference check, according to various embodiments of the invention. The feedback includes, for example, the interviewers impressions of answers provided by the candidate or written answers, in response interview questions. In a Record Interview Feedback Step 910 the interviewer is presented with the questions that have been assigned to him or her. These questions may optionally be accessed using Computing Devices 140 via Network 130 or via a printout of the format of the interview.

The set of questions to be asked is identified by Candidate Interview Module 800 as the set of questions assigned to the interviewer who is accessing the system. These questions are presented to the interviewer and the interviewer presents these questions to the candidate as part of the interview. In addition, the interviewer is optionally reminded that it is helpful to ask candidates the same questions and score candidates on the same standards. In addition, the interviewer is optionally reminded of any biases that he or she may have based on the information stored in Bias Data Memory 230. In addition, the interviewer is optionally reminded that their feedback may become public to some subset of the set of interviewers for this candidate, the hiring manager, and recruiters or human resources professionals at the interviewer's organization. Reminding the interviewer that the feedback can become public tends to reduce the occurrence of irrelevant reasoning being used to reject a candidate for a job.

Candidate Interview Module 800, via logic similar to Presentation Logic 260, is configured to provide the interviewer an interface, often via a browser or mobile device, which allows the interviewer to record feedback about the candidate and the candidate's responses to the interview questions. This feedback is optionally in the form of prose. Optionally the interviewer can also assign a score to the candidate's response or record some other indication as to how well the candidate addressed each interview question. Scores can be numerical, on an A through F level or a multitude of other indications as to the proficiency of the candidate's response to the interview question(s). In some embodiments, the interviewer is shown a minimum number of characters that should be entered for feedback on the candidate for each interview question. This encourages the candidate to ensure that they are being thorough in exploring the particular question with each candidate. In some embodiments, the time the interviewer spends on each question is recorded a part of Memory 120 including a data structure specifically configured to store this data. The time spent on each question can be computed by determining the time between when the interviewer clicks in the feedback box for one interview question and the feedback box for the next interview question. Recording the time spent on each question, and later displaying that time, encourages interviewers to spend significant time on each interview question.

The interviewer can either record their feedback in real-time as the candidate is responding to the question or questions or the interviewer can record their feedback following the interview.

When the interviewer enters their feedback into Candidate Interview Module 800, the system optionally requires the interviewer to enter a response for every interview question. It is helpful that interviewers ask candidates as many of the same questions as possible, thus in some embodiments, Analyze Feedback Step 920 enforces that the interviewer must have a response to every required question for every candidate by checking feedback as it is entered into the system to confirm that some feedback has been entered by the interviewer for the candidate for each interview question or competency being evaluated. Optionally, hiring managers or phone screeners may add their own questions or competencies to the interview. In this case, logic similar to Presentation Logic 260 allows the entry of new questions/competencies and these are optionally stored in a part of Memory 120 including a data structure specifically configured to store this data.

While the interviewer is entering their feedback into Candidate Interview Module 800, the system optionally reminds the interviewer of potential biases that the interviewer possesses based on the information stored in Bias Data Memory 230. In addition, while the interviewer is entering their feedback into Candidate Interview Module 800, the system will optionally remind the interviewer that his or her feedback can be made available to a recruiter, hiring manager, and other interviewers. When the interviewer knows that their feedback may be visible to other interviewers, research has shown that providing visibility and, therefore, accountability of the feedback entered by multiple interviewers tends to reduce the occurrence of interviewers giving a candidate a poor review due to something that is not relevant to whether or not the candidate can perform their job.

Optionally, for each candidate or for each question per candidate, Candidate Interview Module 800 will ask each interviewer to score the candidate. Scores can be numerical values, A-F grades, or some other methodology for indicating the likelihood that the candidate will perform well at the job being considered.

Either as the interviewer enters their feedback or after the feedback has been entered in Record Interview Feedback Step 910, Candidate Interview Module 800 uses Analyze Feedback Step 920 to optionally analyze the words used in the feedback to determine if any bias exists. Information from the Bias Data Memory 230 is used by Analyze Feedback Step 920 to determine if some bias may or may not exist in the feedback associated with the candidate's interview. The determination of bias made by Analyze Feedback Step 920 can be binary, indicating that bias exists, on a spectrum, giving a score of how much bias exists, or presented in some other way to notify some set of the interviewer, the other interviewers, the hiring manager, the recruiter or recruiters involved or other human resources professionals from the organization about possible biases. For example, using terms like “not a culture fit” can be an indication of bias as this phrase has been associated with interviewers' desire to not hire someone without providing a concrete reason for the hire. Additionally, words like “emotional” or “personality” tend to be used detrimentally against women candidates more frequently than against male candidates. Occurrences of these types of words might be counted or the binary indication of the occurrence of these words might be shown or other algorithms might be used to compute a score or an indication of bias. These calculations may be performed using logic similar to or identical to Bias Scoring Logic 235 and included in Candidate Interview Module 800. This logic is configured to perform calculations such as those discussed with respect to Bias Scoring Logic 235, except that the calculation is used to calculate scores for interview questions and/or the analysis of responses. This logic may include embodiments of Binary Calculation Logic 240 and/or Non-Binary Calculation Logic 245, configured for interview analysis.

In some embodiments, candidate Interview Module 800 uses the date and time of the interview to determine when an interviewer has completed an interview but has not yet entered feedback about the interview. Candidate Interview Module 800 is configured to remind the interviewer, through email, text message, mobile alert, desktop alert, or some other alerting mechanism, to enter their feedback about an interview into Candidate Interview Module 800.

Some embodiments of Candidate Interview Module 800 include a version of Selection Logic 840 configured to select interviewers. This selection may be similar to that of the selection of resume reviewers discussed elsewhere herein. Specifically, Selection Logic 540 may use interviewer profiles stored in Interviewer Profile Memory 810 to facilitate the selection of interviewers so as to reduce or minimize the inherent human bias in an interview. An interviewer suspected of having bias in one area may be assigned interview questions that avoid that area.

Some embodiments of Candidate Interview Module 800 include Candidate Scoring Logic 840 (FIG. 8) that uses the feedback given by each of the interviewers to determine a final score for the candidate. Candidate Scoring Logic 840 can perform linear or non-linear calculations to determine a final score for each candidate based on the scores given to the candidate or to each question asked of the candidate by the interviewers. An example of a non-linear calculation could be a weighted average of the scores based on an indication of the hiring manager of how important each question is to the indication of whether or not the candidate will perform well in the job.

Candidate Interview Module 800 typically includes an embodiment of Presentation Logic 260 configured to facilitate the interview process. This embodiment of Presentation Logic 260 can include, for example, logic configured to generate a first user interface configured for a human user to interact with components of j ob candidate interviews including determining the questions to be used during the interviews by each interviewer. These embodiments may also include logic configured to generate a second user interface configured for a human user to interact with components of job candidate interviews including allowing each interviewer to provide feedback on the interview of the candidate.

A similar process to the one described for entering feedback about interviews is carried out when a hiring manager or phone screener assigned by the hiring manager wants to perform a phone screen or a set of phone screens. In the case of a phone screen Candidate Interview Module 800 prompts the hiring manager or phone screener with each question to be asked of each candidate during the phone screen process. Candidate Interview Module 800 optionally reminds the hiring manager or phone screener that candidates must be asked the same or similar set of questions or evaluate the same or similar set of competencies during the phone screen. Optionally, hiring managers or phone screeners may add their own questions or competencies to the interview. In this case, Presentation Logic 260 allows the entry of new questions/competencies. The hiring manager or phone screener then enters answers and feedback about the candidate into Candidate Interview Module 800. Indication of bias, obtained from Bias Data Memory 230, is optionally used to notify the hiring manager or phone screener about potential bias in the answers and/or feedback recorded in Candidate Interview Module 800. The indication of bias can be shown in real-time or could be determined after the fact.

A similar process to the one described for entering feedback about interviews is carried out when a hiring manager or reference checker assigned by the hiring manager wants to perform a reference check or a set of reference checks. In the case of a reference check Candidate Interview Module 800 prompts the hiring manager or reference checker with each question to be asked of each candidates' reference during the reference check process. Candidate Interview Module 800 optionally reminds the hiring manager or reference checker that candidates should be asked many of the same questions during the reference check. Optionally, hiring managers or phone screeners may add their own questions or competencies to the interview. In this case, Presentation Logic 260 allows the entry of new questions/competencies. The hiring manager or phone screener then enters answers and feedback about the reference check into Candidate Interview Module 800. Indication of bias, obtained from Bias Data Memory 230, is optionally used to notify the hiring manager or phone screener about potential bias in the answers and/or feedback recorded in Candidate Interview Module 800. The indication of bias can be shown in real-time or could be determined after the fact.

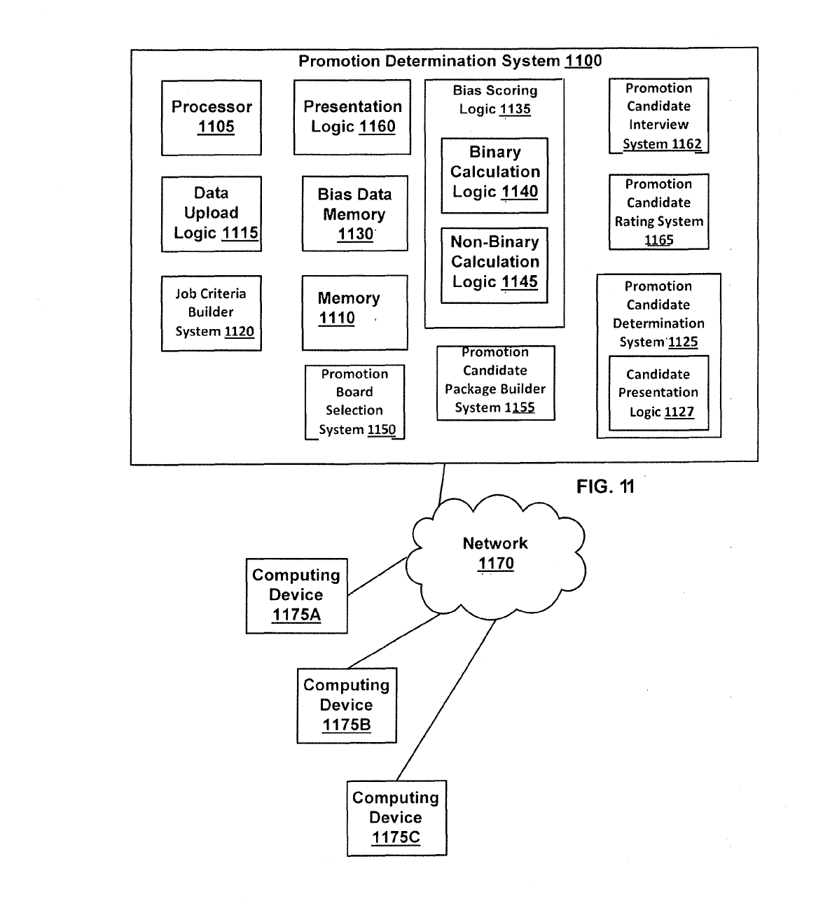

FIG. 10 is an illustration of how Candidate Interview Module 800 is used by the hiring manager, recruiter, or other interviewers to view the feedback about a candidate interview, phone screen, or reference check. In the case of a candidate interview, the answers and feedback recorded by all or several of the interviewers of the candidate can be viewed through Candidate Interview Module 800 via View Feedback Step 1010. Optionally, if Candidate Scoring Logic 840 was used to compute a score for each candidate, the candidates can be shown in order of the final score given to them. Optionally, if timing for each interview question has been recorded, this information can be shown as part of the feedback given by each interviewer. Once the feedback from all interviewers has been entered, the recruiter and the hiring manager receive an email from Candidate Interview Module 800 notifying them that all feedback has been received. The recruiter and the hiring manager can check at any time via View Feedback Step 1010 to see which interviewers have entered their feedback and which interviewers still need to enter their feedback. The feedback can include answers to specific questions, ratings by the interviewer for each answer, a summary of an interview, and/or the like.

The recruiter can see the feedback of any interviews that have been conducted at any time via View Feedback Step 1010. The hiring manager and other interviewers can see the feedback of any interview that has been conducted only after the hiring manager or interviewer has entered their own feedback into the system.

Once the hiring manager has reviewed all of the feedback of the interviewers via View Feedback Step 1010, the hiring manager will be prompted to determine whether they want to move forward with a particular candidate. Candidate Interview Module 800 will record the hiring manager's decision for each candidate via a Record Candidate Decisions Step 1020 and will optionally send out a notification to some set of the recruiter, the interviewers, and the candidates about the decision made about the candidate.

Possible decisions about candidates can include, but are not limited to, “hire”, “hold until other candidates have been interviewed”, “hold until other candidates have been phone screened”, “hold until other candidates have had their references checked”, “no longer consider for this position”, etc. Candidate Interview Module 800 can take a multitude of appropriate actions depending on the decision of the hiring manager. Some of this actions can include, but or not limited to, notifying the recruiter of the decision, sending notification to the candidate, sending notification to the other interviewers, initiating a process within the organization's human resources systems to hire the candidate, etc.

A similar process to the one described for reviewing interview feedback is also used for reviewing feedback on both phone screens and reference checks.

Several embodiments are specifically illustrated and/or described herein. However, it will be appreciated that modifications and variations are covered by the above teachings and within the scope of the appended claims without departing from the spirit and intended scope thereof. For example, while part of the current disclosure is directed at job descriptions, alternative embodiments of the invention may be applied to other organizational products such as company marketing materials, promotional advertisements, and other human resource-related documents. While part of the current disclosure is directed at resumes, in alternative embodiments of the invention the same systems and method used for resumes may be applied to other organizational functions such as candidate interviews, phone screens, and any other interactions with candidates. While the current disclosure is directed at interviews, phone screens, and reference checks, alternative embodiments of the invention may be applied to other organizational products including promotions or other interactions with job candidates or promotion candidates. The systems and methods disclosed herein may be applied to other types of applications such as grant applications, school/college applications, bid solicitation, etc.

The various examples of logic noted above can comprise hardware, firmware, or software stored on a computer-readable medium, or combinations thereof. This logic may be implemented in an electronic device to produce a special purpose computing system. A computer-readable medium, as used herein, expressly excludes paper. Computer-implemented steps of the methods noted herein can comprise a set of instructions stored on a computer-readable medium that when executed cause the computing system to perform the steps. A computing system programmed to perform particular functions pursuant to instructions from program software is a special purpose computing system for performing those particular functions. Data that is manipulated by a special purpose computing system while performing those particular functions is at least electronically saved in buffers of the computing system, physically changing the special purpose computing system from one state to the next with each change to the stored data.

The embodiments discussed herein are illustrative of the present invention. As these embodiments of the present invention are described with reference to illustrations, various modifications or adaptations of the methods and or specific structures described may become apparent to those skilled in the art. All such modifications, adaptations, or variations that rely upon the teachings of the present invention, and through which these teachings have advanced the art, are considered to be within the spirit and scope of the present invention. Hence, these descriptions and drawings should not be considered in a limiting sense, as it is understood that the present invention is in no way limited to only the embodiments illustrated.

Various embodiments of the invention provide a computer based promotion decision tool configured to reduce the inherent bias that is often found in promotion decisions conducted by human decision-makers. The decision-making tool is configured to guide a set of one or more human decision-makers through a process of deciding who gets promoted. This guidance includes, for example, removing as much bias as possible from the description of the job for which the person is being considered for promotion, clearly defining the criteria for which the candidates will be evaluated, ensuring applicable candidates are considered for the promotion, determining a set of decision-makers for the promotion board, creating a promotion package for each candidate, having each member of the promotion board rate each candidate's package, removing or adjusting for the bias from the ratings of each candidate's package by each decision-maker, removing or adjusting for bias from the interviews performed by the promotion board, recording the feedback of the each interview of the candidate and making that feedback public, and then making a decision of which candidate should be promoted. It has been shown that other mechanisms, for example training of human participants, which attempt to remove the biases associated with promotions have been ineffective. Therefore, a programmatic approach is necessary. The use of a computer eliminates or substantially reduces biases that would be inherent to humans performing similar functions.

FIG. 11 is a block diagram illustrating a Promotion Determination System 1100, according to various embodiments of the invention. Promotion Determination System 1100 is optionally the combination of multiple systems configured to determine the most appropriate candidate for a promotion. Promotion Determination System 1100 is optionally part of a larger system that includes one or more of the components disclosed in U.S. provisional patent applications 62/041,515, 62/058,463, 62/085,822 and/or 62/130,429. (The disclosures of these provisional patent applications are hereby incorporated herein by reference.) For example, Promotion Determination System 1100 may be used in conjunction with the Job Description Builder System, disclosed in 62/041,515, to build job descriptions associated with a promotion. By using Job Description Builder System to build the job description that describes the job associated with the promotion it is more likely that underrepresented groups, such as women and minorities, will be interested in applying for the job associated with the promotion. Network 170, Computing Devices 175, Processor 105, Data Upload Logic 115, Presentation Logic 160, Memory 110, Bias Scoring Logic 135, Binary Calculation Logic 140 and Non-Binary Calculation Logic 145 are discussed in detail in U.S. provisional patent applications 62/041,515, 62/058,463, 62/085,822 and/or 62/130,429. These elements may be adapted to be used in Promotion Determination System 100.

Promotion Determination System 1100 and optionally its subsystems may include a personal computer, a server, a web server, a file server, a distributed computing system connected by a network, a communication device, and/or the like. In some embodiments Promotion Determination System 1100 and optionally its subsystems are configured to be accessed over a Network 1170. Network 1170 may be the Internet, a telephone network, a computer network, a local area network, and/or the like. Optionally, Network 1170 is configured for communication via IP/TCP protocols. Promotion Determination System 1100 and optionally its subsystems may be accessed using Computing Devices 1175, such as a user's personal computer, cellular phone, tablet computer, telephone, or the like. Computing Devices 1175 are optionally configured to execute a browser such as Internet Explorer™ or FireFox™ and communicate with Promotion Determination System 1100 and optionally its subsystems via this browser. Computing Devices 1175 are optionally configured to execute an application which is specifically configured to execute on a cellular phone or other personal computing device that receives data through a cellular telephone network or a local area network. Computing Devices 1175 are individually identified as Computing Device 1175A, Computing Device 1175B, etc.

Promotion Determination System 1100 and optionally its subsystems comprise at least one Processor 1105. Processor 1105 includes a microprocessor, an ASIC, a programmable logic array, a communication circuit, a central processing unit, and/or the like. Processor 1105 is typically configured to perform specific tasks by the addition of software and/or firmware. For example, Processor 1105 may be configured to execute any of the logic discussed herein.

Promotion Determination System 1100 and optionally its subsystems further include a Memory 1110 configured to store various sets of information associated with the determination of a promotion. This memory is optionally on one device or multiple devices. The information can be stored in one database or across multiple databases, and in a plethora of other formats and configurations. In some embodiments, Memory 110 includes data structures specifically configured to store part or all of the information associated with the determination of a promotion.

Much work has been done in attempt to train humans on how to remove bias themselves from the promotion process. Despite these efforts, it has been shown that there is inherent bias in the promotion system when these tasks (or some subset of these tasks) are performed by humans. Therefore, it is necessary that Promotion Determination System 1100 be configured to facilitate a machine-structured process in order to interrupt the bias behaviors inherent in humans and make promotions less biased. The tasks performed by Promotion Determination System 1100 would inherently include bias when performed by humans. It is, therefore, a requirement that Promotion Determination System 1100 be a machine based system in order to reduce this inherent bias. In a machine-based system any remaining bias is no longer inherent.

A Job Description Builder System (optionally the same system described in FIG. 11 in Computer Mediated Authoring Tool for Job Descriptions, U.S. provisional patent application Ser. No. 62/041,515), according to various embodiments of the invention. Job Description Builder System is used to create a job description for the position for which a promotion is being considered. The importance of using Job Description Builder System is that this system attempts to make the job description as balanced as possible to not discourage underrepresented groups like women and people of racial minority background from applying for a job or, in this case, a promotion. It is critical to make the job description for a promotion as inclusive as possible since encouraging women and minorities to apply for a promotion is the first step in ensuring the best possible candidate is selected for the promotion and women and minorities have a tendency to not apply for promotions.

Promotion Determination System 1100 optionally includes a Job Criteria Builder System 1120. Job Criteria Builder System 1120 is configured to determine criteria associated with a promotion. Job candidates typically must satisfy some or all of these criteria in order to qualify for the promotion. Specifying ahead of time the criteria associated with a promotion can be defined using Job Criteria Builder System 1120. The specification of criteria facilitates the identification of candidates who might be applicable for a promotion. Job Criteria Builder System 1120 is optionally part of Job Description Builder System disclosed in U.S. provisional patent application 62/041,515. In this case, a description prepared using Job Description Builder can include specific promotion criteria. The selected criteria provide a basis for determining which candidates may or may not be eligible for a particular promotion.

Memory 1110 is configured to store a criteria author's profile. As used herein, the term “criteria author” is used to refer to the human author of the criteria that are required for the job being referenced in the promotion. Memory 1110 is optionally configured to store a database of profiles associated with a plurality of criteria authors. The criteria author profiles include criteria author identification information such as a criteria author login name, a criteria author's name, an identification number, an account name, a password, and/or the like. Typically, Memory 1110 includes a data structure specifically configured to store this information.

The criteria author profiles further include professional and/or personal information regarding the criteria author. This professional and/or personal information can include, but is not limited to the person's job title, the name of the company in which the person is employed, the name of the organization within the company in which the person is employed, the name and identification number of the person's immediate supervisor, the person's gender, the person's birth date, the date of employment for this person at this company, information identifying the person's previous employment history, information identifying the person's education, information about the person's employment performance at this organization, results of various psychological, personality, and other tests completed by the person, the person's race and other information that may identify any biases that may arise from this person. One or more of the tests completed by the person are typically configured to identify biases of that person.

The information may have been entered into the Memory 1110 when it was provided by the person or by the person's supervisor via a browser. The information may have been entered into the Memory 1110 by another process, the Data Upload Logic 1115, configured to upload the data associated with one or more criteria author profiles into the Memory 1110.

For example, the criteria author profile may include information that the criteria author was born on Jan. 1, 1971, is female, has been employed with the Acme Corporation since Jan. 1, 2003 and held the title of Director of Engineering from Jan. 1, 2003 to Jan. 1, 2005, the title of Sr. Director of Engineering from Jan. 1, 2005 to Jul. 31, 2009, and Vice President of Engineering from Aug. 1, 2009 to the present. Additionally, the Memory 1110 can optionally contain information about the criteria author that would indicate potential bias by the criteria author. Example information that could indicate the criteria author's bias includes, but is not limited to where the criteria author went to school, the ethnicity of the criteria author, any religious affiliations of the criteria author, any cultural or athletic affiliations of the criteria author, indication of the criteria author's socio-economic background, results of personality, psychological, or other tests that might indicate various types of biases, feedback from co-workers and managers, etc.

Job Criteria Builder System 1120 further uses Memory 1110 to store sets of criteria that are required for specific jobs. Memory 1110 is optionally configured to store a database of sets of criteria associated with a plurality of jobs. The job criteria database includes job identification information including the title of the job, the department of the job, the hiring manager for the job, and the author of the criteria and a list of criteria associated with the job, among other things. Examples of criteria that might be recorded for the job include, but are not limited to, “Must have managed a team of at least 12 people”, “Must have held profit/loss responsibility”, “Must have at least three years experience at this company”, “Must have a master's degree in engineering”, “Must have executed sales of at least $12 M per year in a prior position”, etc. Typically, Memory 1110 includes a data structure specifically configured to store this information.

The information may have been entered into the Memory 1110 via a browser when it was provided by the person responsible for creating the job criteria. Alternately, it may have been entered into the Memory 1110 by another process, the Data Upload Logic 1115, is further configured to optionally upload the data associated with one or more criteria author profiles into the Memory 1110.

Criteria associated with jobs stored in Memory 1110 are optionally grouped in job “families.” Job families may include jobs in the same company, in the same organization, having similar titles and/or responsibilities, having similar criteria, or any multidimensional combination of the above.

Job Criteria Builder System 1120 further uses bias data that consists of various forms of biases, various indicators of those biases, various techniques for mitigating those biases and various descriptions of the biases, and/or the reasoning behind the biases and the mechanisms for mitigating the biases. This “bias data” is optionally stored in Memory 1110.

The bias data optionally contains one or more of the following: words and/or phrases that could be included in job criteria that are known to be biased against gender, race, or some other demographic or stereotype (an example is using the word “competitive leader” which is known to be associated with white men and not with women and/or minorities); the types of criteria that could exclude or include various demographics (for example, including things like “Must have mentored employees” is more likely to include women and, therefore, is a balanced criteria to include in the set of criteria for a job, as is including things like “Has participated in some of the important, though more mundane, tasks of the group like taking notes in meetings, organizing parties, etc.”); etc

The bias data optionally contains words or phrases that can be used as part of mitigation techniques for removing bias or descriptions of procedures that can be taken to remove bias from the set of criteria associated with a particular job. Examples of a data and procedures that can be used for mitigation techniques include but are not limited to changing a biased term to a neutral term (for example, changing “competitive leader” to “collaborative leader” or suggesting that criteria include things like mentoring or having performed important, but mundane, office tasks). Some embodiments of the invention include ensuring that the criteria is based on performance and not on potential since potential is much more qualitative and women and minorities tend to be judged more harshly on potential then white men, etc.

The bias data optionally contains a ranking, priority, or some other type of scoring of the criteria associated with a job or set of jobs based on the importance of the various criteria to how well the prospective candidate who may or may not have that criteria could perform the job in question. This ranking, priority, or scoring could be binary in that it could specify which criteria are required versus which are preferred, it could assign numerical values to each criterion, or various other methods for identifying the relative priority of the criteria, or some combination of these methods.

Job Criteria Builder System 1120 optionally makes use of Bias Scoring Logic 135 configured to analyze job criteria (as a set or individual criterion) and to calculate a criteria bias score that is the indication of the amount of bias present in the job criteria (a criteria bias score). In some embodiments, Bias Scoring Logic 1135 includes computer code configured to present a web interface to a user within a browser. In some embodiments, Bias Scoring Logic 1135 includes computer code configured to present an interface to a person through their cellular telephone or other telecommunication device. In this case there is often an application created that is used on the phone or other communication device.

Example calculations that can be performed by the Bias Scoring Logic 1135 include, but are not limited to, the indication of biased terms, the lack of using criteria that are known to be inclusive of women and/or minorities, the presence of criteria that relies on potential instead of performance, etc.

A criteria author may enter and/or modify various components of a set of job criteria. The calculation of the criteria bias score is based on the bias data stored in Memory 110 in combination with the various components of the job criteria. The criteria bias score represents a result of a calculation of the various components of the bias data as a function of the information in the job criteria. In various embodiments, there are a wide variety of methods by which a score can be calculated. In some embodiments an equation (e.g., a linear equation) is used that includes bias values multiplied by coefficients. The coefficients are based on information such as magnitude of bias per component or number of existing components that represent bias among others.

The criteria bias score calculated using Bias Scoring Logic 1135 is typically configured for showing the user of the system, e.g., the criteria author or modifier of the job criteria. The criteria bias score indicates to the criteria author or modifier when their changes or additions to a set of job criteria make that job criteria more or less biased. The criteria bias score generated by Bias Scoring Logic 1135 can optionally be displayed in real-time and/or be displayed based on a previous calculation. An example of the criteria bias score being displayed in real-time includes when the criteria author types the word “competitive leader”, the criteria bias score would change immediately and the word would be highlighted to show that it is known to be a word that can make fewer women or minorities applicable for the job. Bias Scoring Logic 1135 is optionally configured to calculate a grade based on a criteria bias score. A grade is a representation of a criteria bias score normalized to a grading scale such as A to F, 1 to 10, one star to five stars, “Very Good” to “Very Bad,” etc. Some embodiments, are configured to enforce a rule requiring a criteria bias score above a minimal level before a set of promotion criteria (or any other scored data discussed herein) can be used.

Bias Scoring Logic 1135 optionally includes Binary Calculation Logic 1140 and a Non-Binary Calculation Logic 1145. Binary Calculation Logic 1140 is configured to calculate a criteria bias score based on binary values, such as the presence of a particular words or phrases in the job criteria. For example, a job criterion may include words or phrases like “competitive leader” which has been shown to be associated with more white men than women or minorities. In this case, a binary score of one may be included indicating that the job criteria is unfairly written to make some employees less applicable to the job since that particular phrase is not usually associated with particular demographics. Binary Calculation Logic 1140 may use Boolean logic. Binary Calculation Logic 1140 is typically used to dramatically alter criteria bias scores for specific components of the job criteria that are absolutely to be avoided. Different factors can be weighted differently in the calculation.

Binary Calculation Logic 1140 optionally includes whether or not the criteria includes the potential of the candidate. It is shown that men tend to get more promotions and higher ratings because criteria authors look at their potential in addition to their accomplishments. Women are often passed over for promotion because the evaluator wants “proof” that a woman can perform in a certain way. Therefore, a job criterion that includes the need for potential may reduce the possibility that women will be promoted.

Binary Calculation Logic 1140 optionally includes whether or not typically female-oriented tasks are included in the job criteria. Because women are often tasked with typically female-oriented tasks (like taking notes in meetings, organizing parties, mentoring others, and the like), this can hurt the appearance of how suited they are for a promotion because these tasks take time but are not often recognized. By prompting the criteria author to indicate which typically female-oriented tasks are important for the job—and remind the criteria author that these tasks are important for the success of the organization—it reduces the likelihood that an employee who has contributed a lot of these typically female-oriented tasks will be rated lower in their candidacy for the promotion than someone who has not performed many typically female-oriented tasks.

Binary Calculation Logic 1140 is optionally configured to calculate criteria bias scores based on whether the criteria author has the possibility of being biased in any way. These calculations are based on a plethora of information included in the criteria author's profiles. For example, including but not limited to the criteria author's background, ethnicity, religion, age, education level, preferences, results of psychological, personality or other tests, indications from the criteria author's co-workers or managers, etc. This information can be used to increase or decrease the criteria bias score based on whether or not the criteria author is likely to have a particular bias. As an example, if a criteria author is known to have attended an Ivy League school and rates education highly in their set of criteria, the criteria may be scored as being more biased than in the case that the criteria author had not rated education as highly relevant to the promotion. In some cases the same criteria authored by different people could have different bias ratings. The bias in the criteria can be used in conjunction with the possible bias in the eventual criteria bias scores given to the applicant packages to determine whether there was bias in rating the candidates. The Bias Scoring Logic 1135 can be configured to calculate any of the scores based on the different input information.

Non-Binary Calculation Logic 1145 is configured to calculate a criteria bias score based on quantitative information within the set of job criteria. For example, the calculation of a criteria bias score may include multiplying the number of biased words by a coefficient. The coefficient can be positive or negative.

Non-Binary Calculation Logic 1145 is optionally configured to calculate criteria bias scores based on whether the criteria author has the possibility of being biased in any way. These calculations are based on a plethora of information including but not limited to the criteria author's background, ethnicity, religion, age, education level, preferences, results of psychological, personality or other tests, indications from the criteria author's co-workers or managers, etc. This information can be used to increase or decrease the criteria bias score based on whether or not the criteria author is likely to have a particular bias.

Job Criteria Builder System 1120 typically uses Presentation Logic 1160 configured to provide criteria bias scores and or grades to a criteria author and to allow a criteria author to make changes or additions to their job criteria to influence their criteria bias score. In typical embodiments, Presentation Logic 1160 is configured to generate computing instructions (e.g., html, xml, scripts, java, or the like) configured to present an interface to a criteria author within a browser. Alternatively, Presentation Logic 1160 is configured to present information to a criteria author via a software agent. Part of Presentation Logic 1160 is optionally disposed on Computing Device 1175.

In some embodiments, Presentation Logic 1160 is configured to show the criteria author how far the criteria author's selection of criteria deviates from the average, a mean, or some other metric. This can be useful in helping criteria author to not overcompensate for a bias. For example, if an author knows that they are biased towards candidates that attended Ivy League Schools, they may rank the education criterion significantly lower than they believe it should be ranked. By showing the criteria author the average ranking of the education criterion (and other criteria) it gives the author a guidepost as to what is normally specified for that particular criterion. Similarly, the Binary Calculation Logic 1140 and the Non-Binary Calculation Logic 1145 can take into account the deviation of the criteria rankings from the average, a mean, or some other metric.

Presentation Logic 1160 is typically configured to receive inputs from a criteria author. These inputs may include text to be included in various components of the job criteria, priorities of various components of the job criteria, commands to print a set of job criteria or groups of job criteria, customization of a criteria author profile, the ability to save a set of job criteria, the ability to analyze a set of job criteria, the ability to indicate that a set of job criteria is ready for review by another user, and/or the like. For example, in some embodiments, Presentation Logic 1160 is configured to present a search field to a user through a browser. The search field is configured for a user to search for a set of job criteria by job title, company, organization within the company, author of the job criteria, and/or the like.

Memory 1110 is optionally configured to store the prose associated with the job criteria. This prose can be from the author of the job criteria and can optionally be stored in a separate data structure.

Memory 1110 is optionally further configured to store a priority or other indication of importance associated with various components of the job criteria. For example, a criteria author may indicate that typically female-oriented tasks are less important than quantitative performance outcomes. Typically, Memory 1110 includes a data structure specifically configured to store this information.

Promotion Determination System 1100 optionally includes a Promotion Candidate Determination System 1125. Promotion Candidate Determination System 1125 is configured to determine which candidates might be eligible for the promotion under consideration. This determination is made by comparing the criteria for a promotion to the profiles of individual candidates. These candidate profiles are optionally stored in Memory 1110. Building on the criteria by Job Criteria Builder System 1120, Promotion Candidate Determination System 1125 ensures that some or all candidates who might be applicable for a promotion will be considered for that promotion. This reduces the probability that human bias will exclude qualified candidates.

Promotion Candidate Determination System 1125, uses Memory 1110 configured to store a promotion author's profile. As used herein, the term “promotion author” is used to refer to the human who is determining which employees can be considered candidates for a particular promotion.

Memory 1110 is optionally further configured to store sets of candidates that may be applicable for specific promotions. For example, Memory 1110 is optionally configured to store data or a candidate database of sets of candidates associated with a plurality of jobs. Promotion Candidate Determination System 1125 optionally includes part of Memory 1110. This information may be used by Promotion Candidate Determination System 1125. The candidate database includes job identification information including the title of the job, the department of the job, the hiring manager for the job, and the promotion author of the list of candidates to be considered for the job, and the list of candidates that might be considered for the job, among other things. Included in the information stored about each candidate could be their name, employee identification number, current job title, current department, current manager, and so on. In addition, candidate profiles also include information about various qualifications the candidate might have. Examples of these types of qualification include, but are not limited to, “has managed a team of 12 people”, “has had profit/loss responsibility”, “has increased sales by more then 20% year over year”, “has managed a sales group that generated more than $10 M in yearly revenue”, etc. Typically, Memory 1110 includes a data structure specifically configured to store this information. The comparison between the criteria and the candidate's qualification can be performed automatically using Processor 1105 and/or performed by a person. For example, Promotion Candidate Determination System 1125 optionally includes logic configured to highlight specific terms in a candidate's qualifications and highlight a match between these terms and criteria for presentation to a human reviewer.

The information may have been entered into the Memory 1110 when it was provided by the person responsible for creating the candidate set via a browser. Alternatively, it may have been entered by the candidate themselves as part of a process that prompts the candidate to specify which qualifications they have. Alternately, it may have been entered into the Memory 1110 by another process, the Data Upload Logic 1115, is further configured to optionally upload the data associated with one or more candidate sets into the Memory 1110.

Candidate sets associated with possible promotions stored in Memory 1110 are optionally grouped in job “families.” Job families may include jobs in the same company, in the same organization, having similar titles and/or responsibilities, having similar criteria, or any multidimensional combination of the above.

Candidates associated with possible promotions stored in Memory 1110 are optionally grouped in candidate “families.” Candidate families may include candidates in the same company, in the same organization, having similar titles and/or responsibilities, having similar qualifications, or any multidimensional combination of the above.

Bias Scoring Logic 1135 is optionally further configured to calculate a candidate selection bias score under the control of Promotion Candidate Determination System 1125. For example, Bias Scoring Logic 1135 may be configured to analyze the set of candidates selected to be considered for a promotion (as a set or individual individually) and to calculate a candidate selection bias score that is the indication of the amount of bias present in the selection of possible promotion candidates (a candidate selection bias score). There is inherent bias in the way humans evaluate candidates for promotion and that is why a non-human system is needed to help normalize the way candidates are viewed for a possible promotion

Example calculations that can be performed by the Bias Scoring Logic 1135 include, but are not limited to, whether candidates that were selected to be part of the candidate pool for the promotion do not meet the criteria for the promotion, whether candidates that were not selected to be part of the candidate promotion pool meet some or the criteria required for the promotion, the demographics of the candidates that were or were not chosen to be considered for the promotion candidate set, the similarity of the demographics and other features of the candidate to the promotion author, etc.

A promotion author may enter and/or modify various components of a set of candidate set. The calculation of the candidate selection bias score is based on the information stored in the Memory 1110 where candidate qualifications from the Memory 1110 are compared with job criteria also stored in Memory 1110 in combination with the various components of the demographics of the candidates. In various embodiments, there are a wide variety of methods by which a candidate selection bias score can be calculated. In some embodiments an equation (e.g., a linear equation) is used that includes the sum of the number of met criteria minus the sum of the number of unmet criteria per candidate. In some embodiments an equation (e.g., a linear equation) is used that includes multiplying a coefficient by the sum of the number of met criteria minus a coefficient multiplied by the sum of the number of unmet criteria per candidate. The coefficients are based on information such as priority of the criteria or whether a particular criterion is more likely to include or exclude women and/or minorities (for example, a criteria that says that the candidate must have mentored other employees can be seen as favorable to women and minorities) among others.

The candidate selection bias score calculated using Bias Scoring Logic 1135 is typically configured for showing the user of the system, who is the promotion author or modifier of the candidate set, when their changes or additions to a set of candidates makes that candidate set more or less biased. The candidate selection bias score generated by Bias Scoring Logic 1135 can optionally be displayed in real-time and/or be displayed based on a previous calculation. An example of the candidate selection bias score being displayed in real-time includes when the promotion author selects a candidate to be added to the candidate set and that candidate does not meet the criteria for the promotion, the candidate selection bias score would change immediately and the candidate (and possibly the criterion that is not meant) would be highlighted to show that the particular candidate may not have all or enough criteria for the job. As an example, including a candidate who doesn't meet all of the criteria but attended Harvard while excluding a candidate who meets all of the criteria but didn't attend Harvard would be considered biased. Bias Scoring Logic 1135 is optionally configured to calculate a grade based on a candidate selection bias score. A grade is a representation of a candidate selection bias score normalized to a grading scale such as A to F, 1 to 10, one star to five stars, “Very Good” to “Very Bad,” etc.

Bias Scoring Logic 1135 optionally includes Binary Calculation Logic 1140 and a Non-Binary Calculation Logic 1145. Binary Calculation Logic 1140 is configured to calculate a candidate selection bias score based on binary values, such as whether or not one of the candidates meet some or all of the criteria for the job. In this case, a binary candidate selection bias score of one may be included indicating that the candidate is unfairly being considered for the promotion when other candidates should also be considered. Binary Calculation Logic 1140 may use Boolean logic. Binary Calculation Logic 1140 is typically used to dramatically alter candidate selection bias scores for specific components of the job criteria that are absolutely to be avoided. Different factors can be weighted differently in the calculation.

Binary Calculation Logic 1140 optionally includes whether or not the candidate meets some or all of the criteria for the job. It is shown that men are often considered for jobs based on their potential (and, therefore, don't have to meet all criteria before being considered).

Binary Calculation Logic 1140 optionally includes whether or not the candidate that does or does not meet the criteria for the job is from an under-represented group. Since under-represented groups are often required to meet more criteria than majority groups, the candidate selection bias score may indicate when someone from an under-represented group is being unfairly excluded based on criteria met from candidates of a majority group.

Binary Calculation Logic 1140 is optionally configured to calculate candidate selection bias scores based on whether the promotion author has the possibility of being biased in any way. These calculations are based on a plethora of information including but not limited to the promotion author's background, ethnicity, religion, age, education level, preferences, results of psychological, personality or other tests, indications from the promotion author's co-workers or managers, etc. This information can be used to increase or decrease the candidate selection bias score based on whether or not the promotion author is likely to have a particular bias. As an example, it has been shown that similarities between a candidate and a promotion author can make a promotion author more favorable toward a candidate and, therefore, possibly include a candidate who is not qualified. As an example, if a promotion author went to Harvard and selects a candidate who does not meet all criteria but that candidate attended Harvard, and/or the same promotion author does not select another candidate who meets all of the criteria but did not go to Harvard, this could indicate some bias in the selection. Based on this it is possible that the same set of candidates selected by two different promotion authors would have different candidate selection bias scores associated with them.

Non-Binary Calculation Logic 1145 is configured to calculate a candidate selection bias score based on quantitative information within the set of job criteria and candidate qualifications. For example, the calculation of a candidate selection bias score may include multiplying the number of criteria not met for a particular candidate by a coefficient. The coefficient can be positive or negative. In addition, the candidate selection bias score may be weighted based on the demographic information of the candidate—such as whether the candidate is in a majority or under-represented group.

Non-Binary Calculation Logic 1145 is optionally configured to calculate candidate selection bias scores based on whether the promotion author has the possibility of being biased in any way. These calculations are based on a plethora of information including but not limited to the promotion author's background, ethnicity, religion, age, education level, preferences, results of psychological, personality or other tests, indications from the promotion author's co-workers or managers, etc. This information can be used to increase or decrease the candidate selection bias score based on whether or not the promotion author is likely to have a particular bias. As an example, it has been shown that similarities between a candidate and an promotion author can make an promotion author more favorable toward a candidate and, therefore, possibly include a candidate who is not qualified.

Promotion Candidate Determination System 1125 typically includes Candidate Presentation Logic 1127 configured to show the promotion author a list of possible candidates that can be considered for a promotion. The list of possible candidates that can be considered for a promotion is derived from the list of employees of an organization. This list of employees is usually stored in Memory 1110 and includes the list of employees, the qualifications each employee has achieved, etc.

Candidate Presentation Logic 1127 is configured to allow a promotion author to select a particular job for which there is going to be a promotion available and then see the criteria that has been assigned to this job. The criteria are optionally stored in a part of Memory 1110 having a specific data structure configured to store criteria.

Presentation Logic 1160 is configured to allow a promotion author to select a set of candidates that can be considered for a particular promotion. The candidates are displayed to the promotion author with the list of qualification that each candidate has achieved.

One embodiment of the invention has the promotion author determine which candidates meet the criteria associated with a particular job. An alternative embodiment of the invention has a processor determine which candidates have met the criteria associated with a job and then Presentation Logic 1160 shows the promotion author the candidates that are applicable for the job.

Presentation Logic 1160 allows the promotion author to add and remove candidates to the candidate set for the promotion.

Presentation Logic 1160 is configured to optionally provide the candidate selection bias scores and other scores discussed herein and or grades to a promotion author and to allow a promotion author to make changes or additions to their candidate set to influence the candidate selection bias score. In typical embodiments, Presentation Logic 1160 is configured to generate computing instructions (e.g., html, xml, scripts, java, or the like) configured to present an interface to a promotion author within a browser. Alternatively, Presentation Logic 1160 is configured to present information to a promotion author via a software agent. Part of Presentation Logic 1160 is optionally disposed on Computing Device 1175.

In some embodiments, Presentation Logic 1160 is configured to show a promotion author how far the promotion author's selection of a set candidates deviates from the average, a mean, or some other metric. This can be useful in helping promotion author to not overcompensate for a bias. For example, if an author knows that they are biased towards candidates that attended Ivy League Schools, they may not choose candidates that have Ivy League educations. By showing the promotion author the average or some other metric of the set of candidates that would be chosen by other promotion authors it gives the promotion author a guidepost as to what is normally specified for a set of candidates. Similarly, the Binary Calculation Logic 1140 and the Non-Binary Calculation Logic 1145 can take into account the deviation of the candidate set from the average, a mean, or some other metric.

Presentation Logic 1160 is typically configured to receive inputs from a promotion author. These inputs may include, but are not limited to, a binary selection for each potential candidate of whether or not that candidate should be included in the set that will be considered for the promotion, text associated with comments about a particular candidate, priorities of various candidates, commands to print a set of candidates or groups of candidate sets, customization of a promotion author profile, the ability to save a set of candidates, the ability to analyze a set of candidates, the ability to indicate that a set of candidates is ready for review by another user, and/or the like. For example, in some embodiments, Presentation Logic 1160 is configured to present a search field to a user through a browser. The search field is configured for a user to search for a candidate or set of candidates by name, job title, company, organization within the company, qualification, and/or the like. In other embodiments, Presentation Logic 1160 is configured to present a search field to a user through a browser where the search field allows the promotion author to search for particular job criteria by searching for a job title, a specific criterion, an author of a criterion, etc.

Memory 1110 is optionally configured to store the prose (e.g., unstructured narrative data) associated with the set of candidates for a promotion. This prose can be from the promotion author of the candidate set. Typically, Memory 1110 includes a data structure specifically configured to store this information.

Promotion Determination System 1100 optionally includes a Promotion Board Selection System 1150. Promotion Board Selection System 1150 is configured to select (human) members of a promotion board. The selected promotion board members will determine which of the qualified candidates receives a particular promotion. Using Promotion Board Selection System 1150 reduces the likelihood that bias occurs in the promotion decision process since Promotion Board Selection System 1150 attempts to create a promotion board that is diverse and that does not know the candidates associated with the promotion, both of which have been shown to reduce bias in promotions.

Promotion Board Selection System 1150 optionally uses a part of Memory 1110 configured to store a promotion board author's profile. As used herein, the term “promotion board author” is used to refer to the human who is determining the people who will be on the promotion board to evaluate the candidates for a particular promotion. Memory 1110 is optionally configured to store a database of profiles associated with a plurality of promotion board authors. The promotion board author profiles include promotion board author identification information such as a promotion board author login name, a promotion board author's name, an identification number, an account name, a password, and/or the like. Typically, Memory 1110 includes a data structure specifically configured to store this information.

The promotion board author profiles further include professional and/or personal information regarding the promotion board author. This professional and/or personal information can include, but is not limited to the person's job title, the name of the company in which the person is employed, the name of the organization within the company in which the person is employed, the name and identification number of the person's immediate supervisor, the person's gender, the person's birth date, the date of employment for this person at this company, information identifying the person's previous employment history, information identifying the person's education, information about the person's employment performance at this organization, results of various psychological, personality, and other tests completed by the person, the person's race and other information that may identify any biases that may arise from this person. One or more of the tests completed by the person are typically configured to identify biases of that person.

The information may have been entered into the Memory 1110 when it was provided by the person or by the person's supervisor via a browser. The information may have been entered into the Memory 1110 by another process, the Data Upload Logic 1115, configured to upload the data associated with one or more promotion board author profiles into the Memory 1110.

For example, the promotion board author profile may include information that the promotion board author was born on Jan. 1, 1971, is female, has been employed with the Acme Corporation since Jan. 1, 2003 and held the title of Director of Engineering from Jan. 1, 2003 to Jan. 1, 2005, the title of Sr. Director of Engineering from Jan. 1, 2005 to Jul. 31, 2009, and Vice President of Engineering from Aug. 1, 2009 to the present. Additionally, the Memory 1110 can optionally contain information about the promotion board author that would indicate potential bias by the promotion board author. Example information that could indicate the promotion board author's bias includes, but is not limited to where the promotion board author went to school, the ethnicity of the promotion board author, any religious affiliations of the promotion board author, any cultural or athletic affiliations of the promotion board author, indication of the promotion board author's socio-economic background, the promotion board author's age, the education level of the promotion board author, results of personality, psychological, or other tests that might indicate various types of biases, feedback from co-workers and managers, etc.

Promotion Board Selection System 1150 optionally further uses Memory 1110 configured to store sets of criteria for the composition of a promotion board. Memory 1110 is optionally configured to store a board criteria database of sets of criteria associated with a plurality of jobs associated with promotions. The board criteria database includes job identification information including the title of the job, the department of the job, the hiring manager for the job, and the author of the board criteria and a list of board criteria associated with the job, among other things. Examples of board criteria that might be recorded for a board include, but are not limited to, “Must have at least 3 people”, “Must not have more than 6 people”, “Must have at least one person of under-represented racial heritage”, “Must have at least one woman and one man”, “Must have at least one person who is at the same level of the job being considered for promotion”, “Must have at least one person from a department other than the department where the promotion is being considered”, “Must not have any people from the department in which the promotion is being considered”, “Must have no one on the committee who knows any of the candidates”, etc. These criteria are optionally stored as logical rules. Typically, Memory 1110 includes a data structure specifically configured to store this information.

The information may have been entered into the Memory 1110 when it was provided by the person responsible for creating the board criteria via a browser. Alternately, it may have been entered into the Memory 1110 by another process, the Data Upload Logic 1115, is further configured to optionally upload the data associated with one or more promotion board author profiles into the Memory 1110.

Board criteria associated with jobs stored in Memory 1110 are optionally grouped in job “families.” Job families may include jobs in the same company, in the same organization, having similar titles and/or responsibilities, having similar criteria, or any multidimensional combination of the above.

Promotion Board Selection System 1150 optionally further uses a part of Memory 1110 configured to store information about various forms of biases, various indicators of those biases, various techniques for mitigating those biases and various descriptions of the biases, and/or the reasoning behind the biases and the mechanisms for mitigating the biases in the process of selecting a board to determine a promotion.

The Memory 1110 optionally contains one or more of the following: the number of people that should be on a promotion board to reduce bias, the gender breakdown of the people on the promotion board, the racial breakdown of the people on the promotion board, the number of people on the promotion board that should or should not know the candidates being considered for promotion, etc. Typically, Memory 1110 includes a data structure specifically configured to store this information.

Memory 1110 optionally contains descriptions of procedures that can be taken to remove bias from the set of criteria associated with a particular job. Examples of procedures that can be used for mitigation techniques include but are not limited to ensuring the appropriate number of people are on the promotion board, ensuring the departments represented on the promotion board are appropriate, ensuring the appropriate gender mix of the people on the promotion board, ensuring the appropriate racial mix of the people on the promotion board, etc.

Promotion Board Selection System 1150 optionally further uses a part of Bias Scoring Logic 1135 configured to analyze board criteria (as a set or individual criterion) and to calculate a score that is the indication of the amount of bias present in the promotion board (a promotion board bias score).

Example calculations that can be performed by the Bias Scoring Logic 1135 include, but are not limited to, the balance of gender required by the board criteria, the balance of racial representation required by the board criteria, whether or not the criteria includes the fact that none of the board members should know any of candidates, whether or not the board criteria requires a breadth of seniority levels, the similarity between the promotion board author and each of the board members, etc.

A promotion board author may enter and/or modify various components of a set of board criteria. The calculation of the promotion board bias score is based on the information stored in the Memory 1110 in combination with the various components of the board criteria. The promotion board bias score represents a result of a calculation of the various components of the Memory 1110 as a function of the information in the board criteria. In various embodiments, there are a wide variety of methods by which a promotion board bias score can be calculated. In some embodiments an equation (e.g., a linear equation) is used that includes bias values multiplied by coefficients. The coefficients are based on information such as magnitude of bias per component or number of existing components that represent bias among others.

The promotion board bias score calculated using Bias Scoring Logic 1135 is typically configured for showing the user of the system, who is the author or modifier of the board criteria, when their changes or additions to a set of board criteria make that board criteria more or less biased. The promotion board bias score generated by Bias Scoring Logic 1135 can optionally be displayed in real-time and/or be displayed based on a previous calculation. An example of the promotion board bias score being displayed in real-time includes when the promotion board author create a criterion for including at least one male and one female on the board, the promotion board bias score would change immediately to show that the criteria set is now less biased than before that criterion was included. Bias Scoring Logic 1135 is optionally configured to calculate a grade based on a promotion board bias score. A grade is a representation of a promotion board bias score normalized to a grading scale such as A to F, 1 to 10, one star to five stars, “Very Good” to “Very Bad,” etc.

Bias Scoring Logic 1135 optionally includes Binary Calculation Logic 1140 and Non-Binary Calculation Logic 1145. Binary Calculation Logic 1140 is configured to calculate a promotion board bias promotion board bias score based on binary values, such as the presence of a criterion within the set of board criteria. For example, a board criterion may ensure that there is a mix of racial backgrounds on the board and this could positively impact the promotion board bias score—indicating that the board criterion will reduce bias. Binary Calculation Logic 1140 may use Boolean logic. Binary Calculation Logic 1140 is typically used to dramatically alter promotion board bias scores for specific components of the board criteria that are absolutely to be included or avoided. Different factors can be weighted differently in the calculation.

Binary Calculation Logic 1140 optionally includes whether or not the criteria includes a racial mix of the board. It is shown that having a racial mix on a promotion board will reduce the bias towards candidates from racial minorities. Therefore, a board criterion that includes the need for a racial mix on the promotion board will reduce the possibility of bias in the promotion decision.

Binary Calculation Logic 1140 optionally includes whether or not the criteria includes a gender mix of the board. It is shown that having a gender mix on a promotion board will reduce the bias towards candidates from underrepresented genders. Therefore, a board criterion that includes the need for a gender mix on the promotion board will reduce the possibility of bias in the promotion decision.

Binary Calculation Logic 1140 optionally includes whether or not the criteria includes a mix of other types of underrepresented groups on the board. Examples of other underrepresented groups could be groups with underrepresented sexual orientation, underrepresented physical abilities (or lack thereof), underrepresented religious backgrounds, underrepresented educational backgrounds, underrepresented socio-economic backgrounds, age, education levels, and so on. It is shown that having a mix of underrepresented groups on a promotion board will reduce the bias towards candidates from underrepresented groups. Therefore, a board criterion that includes the need for a mix of underrepresented groups on the promotion board will reduce the possibility of bias in the promotion decision.

Binary Calculation Logic 1140 optionally includes whether or not the criterion specifies that none of the board members can know any of the candidates. It is shown that when board members do not know the promotion candidates the board members are less likely to be influenced by familiarity-bias (bias that comes from liking someone as a person regardless of how capable they are of doing the job). Therefore, a board criterion that includes the need for the board members to not know any of the candidates will reduce the possibility of bias in the promotion decision.

Binary Calculation Logic 1140 is optionally configured to calculate promotion board bias scores based on whether the promotion board author has the possibility of being biased in any way. These calculations are based on a plethora of information including but not limited to the promotion board author's background, ethnicity, religion, preferences, age, education level, results of psychological, personality or other tests, indications from the promotion board author's co-workers or managers, etc. This information can be used to increase or decrease the promotion board bias score based on whether or not the promotion board author is likely to have a particular bias. As an example, if some or all of the board members are shown to be similar to the promotion board author (where similarity is defined by shared demographics, shared interests, shared backgrounds, etc.), then the board is more likely to be biased.

Non-Binary Calculation Logic 1145 is configured to calculate a promotion board bias score based on quantitative information within the set of board criteria. For example, the calculation of a promotion board bias score may include multiplying the percent of the board makeup required to be from certain underrepresented groups by a coefficient. The coefficient can be positive or negative. For example, the closer a promotion board is to 50% men and 50% women the less likely it is to be biased. Therefore, Non-Binary Calculation Logic 1145 might multiply a coefficient by the percent of the promotion board that is comprised of women. The same type of calculation can be performed for other types of underrepresented groups such as race, sexual orientation, religious background, socio-economic background, education level, etc.

Non-Binary Calculation Logic 1145 is optionally configured to calculate promotion board bias scores based on whether the promotion board author has the possibility of being biased in any way. These calculations are based on a plethora of information including but not limited to the promotion board author's background, ethnicity, religion, preferences, age, education level, results of psychological, personality or other tests, indications from the promotion board author's co-workers or managers, etc. This information can be used to increase or decrease the promotion board bias score based on whether or not the promotion board author is likely to have a particular bias. As an example, if some or all of the board members are shown to be similar to the promotion board author (where similarity is defined by shared demographics, shared interests, shared backgrounds, etc.), then the board is more likely to be biased.

Promotion Board Selection System 1150 typically uses Presentation Logic 1160 configured to provide promotion board bias scores and or grades to a promotion board author and to allow a promotion board author to make changes or additions to the board criteria to influence the promotion board bias score. In typical embodiments, Presentation Logic 1160 is configured to generate computing instructions (e.g., html, xml, scripts, java, or the like) configured to present an interface to a promotion board author within a browser. Alternatively, Presentation Logic 1160 is configured to present information to a promotion board author via a software agent. Part of Presentation Logic 1160 is optionally disposed on Computing Device 1175.

In some embodiments, Presentation Logic 1160 is configured to show the promotion board author how far the promotion board author's selection of a promotion board deviates from the average, a mean, or some other metric. This can be useful in helping the promotion board author to not overcompensate for a bias. For example, if a promotion board author knows that they are biased towards promotion board members that attended Ivy League Schools, they may choose promotion board members that do not have Ivy League educations over those that do. By showing the promotion board author the average number, or some other metric, of promotion board members that have Ivy League educations it gives the promotion board author a guidepost as to the promotion boards that are usually chosen. Similarly, the B Binary Calculation Logic 1140 and the Non-Binary Calculation Logic 1145 can take into account the deviation of the promotion board members from the average, a mean, or some other metric.

Presentation Logic 1160 is typically configured to receive inputs from a promotion board author. These inputs may include text to be included in various components of the board criteria, a selection from a dropdown list of the possible criteria for the board makeup, a selection from a dropdown list for a percent of the board that should be of one type or another, commands to print a set of board criteria or groups of board criteria, customization of a promotion board author profile, the ability to save a set of board criteria, the ability to analyze a set of board criteria, the ability to indicate that a set of board criteria is ready for review by another user, and/or the like. For example, in some embodiments, Presentation Logic 1160 is configured to present a search field to a user through a browser. The search field is configured for a user to search for a set of board criteria by job title, company, organization within the company, author of the board criteria, and/or the like.

Memory 1110 is optionally configured to store the prose associated with the board criteria. This prose can be from the author of the board criteria.

Memory 1110 is optionally configured to store a selection from a predefined list associated with the board criteria. This selection can be from the author of the board criteria. Typically, Memory 1110 includes a data structure specifically configured to store this information.

Promotion Board Selection System 1150 further uses Memory 1110 configured to store sets of board members for the composition of a promotion board. Memory 1110 is optionally configured to store a database of sets of board members associated with a plurality of jobs associated with promotions. The board member database includes job identification information including the title of the job, the department of the job, the hiring manager for the job, and the author of the list of board members and a list of board members associated with the job, among other things. Typically, Memory 1110 includes a data structure specifically configured to store this information.

Memory 1110 is optionally configured to store a database of profiles of potential board members that can be assigned to a plurality of jobs associated with promotions. The board member profiles further include professional and/or personal information regarding the board member. This professional and/or personal information can include, but is not limited to the person's job title, the name of the company in which the person is employed, the name of the organization within the company in which the person is employed, the name and identification number of the person's immediate supervisor, the person's gender, the person's birth date, the date of employment for this person at this company, information identifying the person's previous employment history, information identifying the person's education, information about the person's employment performance at this organization, results of various psychological, personality, and other tests completed by the person, the person's race and other information that may identify any biases that may arise from this person. One or more of the tests completed by the person are typically configured to identify biases of that person.

The information may have been entered into the Memory 1110 when it was provided by the person or by the person's supervisor via a browser. The information may have been entered into the Memory 1110 by another process, the Data Upload Logic 1115, configured to upload the data associated with one or more promotion board author profiles into the Memory 1110.

For example, the board member profile may include information that the board member was born on Jan. 1, 1971, is female, has been employed with the Acme Corporation since Jan. 1, 2003 and held the title of Director of Engineering from Jan. 1, 2003 to Jan. 1, 2005, the title of Sr. Director of Engineering from Jan. 1, 2005 to Jul. 31, 2009, and Vice President of Engineering from Aug. 1, 2009 to the present. Additionally, the Memory 1110 can optionally contain information about the board member that would indicate potential bias by the board member. Example information that could indicate the board member's bias includes, but is not limited to where the board member went to school, the ethnicity of the board member, any religious affiliations of the board member, any cultural or athletic affiliations of the board member, indication of the board member's socio-economic background, results of personality, psychological, or other tests that might indicate various types of biases, feedback from co-workers and managers, etc. Optionally, Memory 1110 includes a data structure specifically configured to store this information.

The information may have been entered into Memory 1110 when it was provided by the person responsible for creating the promotion board (at a later time) via a browser. Alternately, it may have been entered into the Memory 1110 by another process, the Data Upload Logic 1115, is further configured to optionally upload the data associated with one or more promotion board author profiles into Memory 1110.

Promotion Board Selection System 1150 optionally further uses part of Bias Scoring Logic 1135 configured to analyze a set of board members and to calculate a score that is the indication of the amount of bias present in the selection of board members (a board member bias score).

Example calculations that can be performed by the Bias Scoring Logic 1135 include, but are not limited to, the balance of gender present in the board members selected for a board, the balance of racial representation in the board members selected for a board, whether or not the board members know any of candidates, the breadth of seniority levels in the board members selected for a board, etc.

A promotion board author may enter and/or modify various components of a set of board members. The calculation of the board member bias score is based on the information stored in the Memory 1110 in combination with the various components of the set of board members selected for a particular board. The board member bias score represents a result of a calculation of the various components of the Memory 1110 as a function of the profiles of the board members selected to serve on a particular board. In various embodiments, there are a wide variety of methods by which a board member bias score can be calculated. In some embodiments an equation (e.g., a linear equation) is used that includes bias values multiplied by coefficients. The coefficients are based on information such as magnitude of bias per component or number of existing components that represent bias among others.

The board member bias score calculated using Bias Scoring Logic 1135 is typically configured for showing the user of the system, who is the author or modifier of the selected set of board members, when their changes or additions to a set of board members make that promotion board more or less biased. The board member bias score generated by Bias Scoring Logic 1135 can optionally be displayed in real-time and/or be displayed based on a previous calculation. An example of the board member bias score being displayed in real-time includes when the promotion board author creates a promotion board that includes at least one male and one female, the board member bias score would change immediately to show that the board is now less biased than when there were only board members of one gender included. Bias Scoring Logic 1135 is optionally configured to calculate a grade based on a board member bias score. A grade is a representation of a board member bias score normalized to a grading scale such as A to F, 1 to 10, one star to five stars, “Very Good” to “Very Bad,” etc.

Bias Scoring Logic 1135 optionally includes Binary Calculation Logic 1140 and Non-Binary Calculation Logic 1145. Binary Calculation Logic 1140 is configured to calculate a board member bias score based on binary values, such as the presence of a particular demographic within the promotion board members. For example, a board criterion may ensure that there is a mix of racial backgrounds on the board and when board members from different racial backgrounds are added to the promotion board this could positively impact the board member bias score—indicating that the proposed set of board members will be less biased. Binary Calculation Logic 1140 may use Boolean logic. Binary Calculation Logic 1140 is typically used to dramatically alter board member bias scores for specific components of the board composition that are absolutely to be included or avoided. Different factors can be weighted differently in the calculation.

Binary Calculation Logic 1140 optionally includes whether or not the board includes a racial mix. It is shown that having a racial mix on a promotion board will reduce the bias towards candidates from racial minorities. Therefore, a board that includes a racial mix will reduce the possibility of bias in the promotion decision.

Binary Calculation Logic 1140 optionally includes whether or not the board includes a gender mix. It is shown that having a gender mix on a promotion board will reduce the bias towards candidates from underrepresented genders. Therefore, a board that includes a gender mix will reduce the possibility of bias in the promotion decision.

Binary Calculation Logic 1140 optionally includes whether or not the board includes a mix of other types of underrepresented groups on the board. Examples of other underrepresented groups could be groups with underrepresented sexual orientation, underrepresented physical abilities (or lack thereof), underrepresented religious backgrounds, underrepresented educational backgrounds, underrepresented socio-economic backgrounds, various ages, various education levels, and so on. It is shown that having a mix of underrepresented groups on a promotion board will reduce the bias towards candidates from underrepresented groups. Therefore, a board that includes a mix of underrepresented groups on will reduce the possibility of bias in the promotion decision.

Binary Calculation Logic 1140 optionally includes whether or not any of the board members know any of the candidates. It is shown that when board members do not know the promotion candidates the board members are less likely to be influenced by familiarity-bias (bias that inherently comes from liking someone as a person regardless of how capable they are of doing the job). Therefore, a board that only includes board members that do not know any of the candidates will reduce the possibility of bias in the promotion decision.

Non-Binary Calculation Logic 1145 is configured to calculate a board member bias score based on quantitative information within the set of board member profiles. For example, the calculation of a board member bias score may include multiplying the percent of the board makeup from certain underrepresented groups by a coefficient. The coefficient can be positive or negative. For example, the closer a promotion board is to 50% men and 50% women the less likely it is to be biased. Therefore, Non-Binary Calculation Logic 1145 might multiply a coefficient by the percent of the promotion board that is comprised of women. The same type of calculation can be performed for other types of underrepresented groups such as race, sexual orientation, religious background, socio-economic background, education level, etc.

Non-Binary Calculation Logic 1145 is optionally configured to calculate board member bias scores based on whether the promotion board author has the possibility of being biased in any way. These calculations are based on a plethora of information including but not limited to the promotion board author's background, ethnicity, religion, age, education level, preferences, results of psychological, personality or other tests, indications from the promotion board author's co-workers or managers, etc. This information can be used to increase or decrease the board member bias score based on whether or not the promotion board author is likely to have a particular bias.

Non-Binary Calculation Logic 1145 is optionally configured to calculate board member bias scores based on the combination of the board member bias score associated with the criteria for selecting the board and the bias present in the board itself. This calculation has several possible implementations. For example, the criteria board member bias score can be used to weight the board member bias scores computed by the binary and non-binary board member calculation logic. Similarly, the board member bias score could be added to the other scores.

Promotion Board Selection System 1150 typically uses Presentation Logic 1160 configured to provide board member bias scores and/or grades to a promotion board author and to allow a promotion board author to make changes or additions to the board members selected for a particular promotion board to influence the board member bias score. In typical embodiments, Presentation Logic 1160 is configured to generate computing instructions (e.g., html, xml, scripts, java, or the like) configured to present an interface to a promotion board author within a browser. Alternatively, Presentation Logic 1160 is configured to present information to a promotion board author via a software agent. Part of Presentation Logic 1160 is optionally disposed on Computing Device 1175.

Presentation Logic 1160 is typically configured to receive inputs from a promotion board author. These inputs may include a selection from a dropdown list of the possible board members for the board makeup, the ability to search for specific possible board members from a list of possible board members, commands to print a set of board criteria or groups of board criteria, customization of a promotion board author profile, the ability to save a set of board members, the ability to analyze a set of board members, the ability to indicate that a set of board members is ready for review by another user, and/or the like. For example, in some embodiments, Presentation Logic 1160 is configured to present a search field to a user through a browser. The search field is configured for a user to search for a set of board members by job title, company, organization within the company, author of the set of board members, and/or the like.

Presentation Logic 1160 is optionally configured to automatically choose and display a set of promotion board members from a set of possible promotion board members. This chosen set is calculated to minimize the board member bias score associated with the set of promotion board members.

Memory 1110 is optionally configured to store a selection from a predefined list associated with a set of board members. This selection can be from the author of the board members. Typically, Memory 1110 includes a data structure specifically configured to store this information.

Promotion Determination System 1100 optionally further includes a Promotion Candidate Package Builder System 1155. Promotion Candidate Package Builder System 1155 is configured to create the candidate packages associated with candidates being considered for promotion. Because candidate packages can have bias included in them, the use of Promotion Candidate Package Builder System 1155 reduces or removes as much bias from the candidate packages themselves, attempting to remove some of the bias inherent in the promotion system.

Promotion Candidate Package Builder System 1155 uses Memory 1110 configured to store a package author's profile. As used herein, the term “package author” is used to refer to the human author that is compiling the various documents that will be used by the promotion board to determine whether or not a promotion candidate should receive a promotion. Components of a candidate package can include, but are not limited to, performance reviews, human resources reports, commendations, recommendations, etc.

Promotion Candidate Package Builder System 1155 optionally further uses a part of Memory 1110 configured to store a list of candidates for a promotion and the corresponding set of information that will be used by the promotion board to evaluate the candidates. Memory 1110 is optionally configured to store a database of sets of information about candidates associated with a plurality of jobs. The candidate package database includes job identification information including the title of the job, the department of the job, the hiring manager for the job, and the author of the packages, and information associated with each candidate, among other things. Examples of information associated with each candidate (heretofore referenced as the “candidate package”) may include, but are not limited to performance reviews, goals that were accomplished, awards or commendations received, letters of reference, 360 reviews, personality and other similar tests, personnel file information (like performance plan, personnel issues reported to Human Resources), etc. Information in Memory 1110 could have been authored by a candidate, a candidate's immediate supervisor, a candidate's colleagues, and a plethora of other people associated with the candidate. Typically, Memory 1110 includes a data structure specifically configured to store this information.

The information may have been entered into the Memory 1110 when it was provided by the person responsible for creating the candidate packages via a browser. Alternatively, it may have been entered into the Memory 1110 by the candidate themselves at the request of the candidate's hiring manager or some other person via a browser. Alternately, it may have been entered into the Memory 1110 by another process, the Data Upload Logic 1115, is further configured to optionally upload the data associated with one or more package author profiles into the Memory 1110.

Packages associated with jobs stored in Memory 1110 are optionally grouped in job “families.” Job families may include jobs in the same company, in the same organization, having similar titles and/or responsibilities, having similar criteria, or any multidimensional combination of the above.

Packages associated with jobs stored in Memory 1110 are optionally grouped in candidate “families.” Candidate families may include candidates from the same company, in the same organization, having similar titles and/or responsibilities, having similar qualifications, or any multidimensional combination of the above.

Promotion Candidate Package Builder System 1155 optionally further uses a part of Memory 1110 configured to store information about various forms of biases, various indicators of those biases, various techniques for mitigating those biases and various descriptions of the biases, and/or the reasoning behind the biases and the mechanisms for mitigating the biases (package bias data).

The package bias data optionally contains one or more of the following: words and/or phrases that are known to be biased against gender, race, or some other demographic or stereotype (an example is using the word “aggressive” which is known to be used for female employees where “assertive” is usually used with male employees another example is using terms like “lack of energy” to describe older employees); the types of performance that should be evaluated for all employees (an example is rating every employee on both accomplishments and potential); including work tasks that tend to be typically female-oriented in the consideration of performance (for example, note taking in meetings, organizing parties, etc.); etc. Typically, Memory 1110 includes a data structured specifically configured to store this information.

Package bias data optionally contains words or phrases that can be used as part of mitigation techniques for removing bias or descriptions of procedures that can be taken to remove bias from a component of a candidate package. Examples of data and procedures that can be used for mitigation techniques include but are not limited to changing a biased term to a neutral term (for example, changing “aggressive” to “assertive” or suggesting that package authors do not use the term “tone” in their performance review), ensuring that all employees are rated on both performance and potential, including typically female-oriented tasks (organizing parties) in evaluating performance for both male and female candidates, etc.

Promotion Candidate Package Builder System 1155 optionally further uses a part of Bias Scoring Logic 1135 configured to parse the components of a candidate package and calculate a score that is the indication of the amount of bias present in the candidate package (a package bias score).

Example calculations that can be performed by the Bias Scoring Logic 1135 include, but are not limited to, the indication of biased terms, the lack of evaluating someone on performance or potential in their performance review, the lack of scoring someone on typically female-oriented tasks in their performance review, etc.

A package author may enter and/or modify various components of a candidate package. The calculation of the package bias score is based on the information stored in the Bias Scoring Logic 1135 in combination with the various components of the candidate package. The package bias score represents a result of a calculation of the various components of the Memory 1110 as a function of the information in the candidate package. In various embodiments, there are a wide variety of methods by which a package bias score can be calculated. In some embodiments an equation (e.g., a linear equation) is used that includes bias values multiplied by coefficients. The coefficients are based on information such as magnitude of bias per component or number of existing components that represent bias among others.

The package bias score calculated using Bias Scoring Logic 1135 is typically configured for showing the user of the system, who is the author or modifier of the candidate package, when their changes or additions to a candidate package make that candidate package more or less biased. This is optionally used only for components of the candidate package that had not been previously scored. The package bias score generated by Bias Scoring Logic 1135 can optionally be displayed in real-time and/or be displayed based on a previous calculation. An example of the package bias score being displayed in real-time includes when the package author sees the word “abrasive” in a performance review, that word may be highlighted. If the package author changes the word to “assertive”, the package bias score would change immediately since “assertive” is known to be less biased than “abrasive”. It should be noted that in the case of modifying the candidate package to adjust the package bias score would likely be done by a package author other than the candidate themselves since allowing the candidate to modify their own package might give that candidate the opportunity to enhance their package. Bias Scoring Logic 1135 is optionally configured to calculate a grade based on a package bias score. A grade is a representation of a package bias score normalized to a grading scale such as A to F, 1 to 10, one star to five stars, “Very Good” to “Very Bad,” etc.

Bias Scoring Logic 1135 optionally includes Binary Calculation Logic 1140 and Non-Binary Calculation Logic 1145. Binary Calculation Logic 1140 is configured to calculate a package bias score based on binary values, such as the presence of a particular words or phrases in the candidate package or set of candidate packages. For example, a candidate package may include words or phrases like “abrasive” or “watch your tone” which have been shown to be included in female performance reviews, but less so in male performance reviews. In this case, a binary package bias score of one may be included indicating that the candidate package unfairly judges the candidate on something that men are not typically judged on. Bias Scoring Logic 1135 may use Boolean logic. Binary Calculation Logic 1140 is typically used to dramatically alter package bias scores for specific components of the candidate packages that are absolutely to be avoided. Different factors can be weighted differently in the calculation.

Binary Calculation Logic 1140 optionally includes whether or not the employee has been rated on both accomplishments and potential in performance reviews. It is shown that men tend to get more promotions and higher ratings because reviewers look at their potential in addition to their accomplishments. Women are often passed over for promotion or given lower ratings in performance reviews because the evaluator wants “proof” that a woman can perform in a certain way. Ensuring that reviews contain both achievements and potential in a systematic way for all candidates, reduces the possibility that women will only be rated lower than men when they have the same performance as a man.

Binary Calculation Logic 1140 optionally includes whether or not typically female-oriented tasks are included in the performance review. Because women are often tasked with typically female-oriented tasks (like taking notes in meetings, organizing parties, mentoring others, and the like), this can hurt the appearance of how well they performed since these tasks take up time but are often not counted towards their accomplishments. By that every candidates' package indicates which typically female-oriented tasks have been accomplished by the candidate the likelihood that a candidate who has contributed a lot of these typically female-oriented tasks will be rated lower in their performance review than someone who has not performed many typically female-oriented tasks is reduced.

Binary Calculation Logic 1140 is optionally configured to calculate package bias scores based on whether the performance reviews included responses to the questions posed by the system about the positive and negative aspects of the employee's performance as part of the free recall portion of the performance review. It has been shown that using free recall to prompt reviewers to give positive and negative comments about every employee can reduce bias. It is possible that the biases that could be present in things like performance reviews could have been removed by other systems that are specifically in place to address bias in those documents.

Binary Calculation Logic 1140 is optionally configured to calculate package bias scores based on whether the author of each component of the candidate package has the possibility of being biased in any way. In this case there are multiple authors since there could be an author of a performance review, a different author who created a commendation, etc. These calculations are based on a plethora of information including but not limited to the component author's background, ethnicity, religion, preferences, age, education level, results of psychological, personality or other tests, indications from the author's co-workers or managers, etc. This information can be used to increase or decrease the package bias score based on whether or not the component author is likely to have a particular bias. In addition, the number of similarities between the author of each component of the package and the candidate can be used to increase or decrease the overall package bias score of the package. Component authors that are similar to candidates tend to be more biased for those candidates.

Non-Binary Calculation Logic 1145 is configured to calculate a package bias score based on quantitative information within the candidate package or a set of candidate packages. For example, the calculation of a package bias score may include multiplying the number of biased words in the package by a coefficient. The coefficient can be positive or negative.

Non-Binary Calculation Logic 1145 is optionally configured to calculate package bias scores based on the number of responses the author of the performance review has included to the questions posed by the system about the positive and negative aspects of the employee's performance as part of the free recall portion of the performance review.

Non-Binary Calculation Logic 1145 is optionally configured to calculate package bias scores based on whether the author of each component of the candidate package has the possibility of being biased in any way. These calculations are based on a plethora of information including but not limited to the component author's background, ethnicity, religion, preferences, age, education level, results of psychological, personality or other tests, indications from the component author's co-workers or managers, etc. This information can be used to increase or decrease the package bias score based on whether or not the component author is likely to have a particular bias. In addition, the number of similarities between the author of each component of the package and the candidate can be used to increase or decrease the overall package bias score of the package. Component authors that are similar to candidates tend to be more biased for those candidates.

Promotion Candidate Package Builder System 1155 typically uses a part of Presentation Logic 1160 configured to provide package bias scores and or grades to a package author and to allow a package author to make changes or additions to the candidate package or set of candidate packages to influence their package bias score. In typical embodiments, Presentation Logic 1160 is configured to generate computing instructions (e.g., html, xml, scripts, java, or the like) configured to present an interface to a package author within a browser. Alternatively, Presentation Logic 1160 is configured to present information to a package author via a software agent.

Presentation Logic 1160 is typically configured to receive inputs from a package author. These inputs may include changes to be made to various components of the candidate packages, commands to distribute a candidate package or set of candidate packages, customization of a package author profile, the ability to save a candidate package or set of candidate packages, the ability to analyze a candidate package or set of candidate packages, the ability to indicate that a candidate package or set of candidate packages is ready for review by another user, and/or the like. For example, in some embodiments, Presentation Logic 1160 is configured to present a search field to a user through a browser. The search field is configured for a user to search for a candidate package by name of the employee, company, organization within the company, author of the candidate package, title of the employee, title of the job for promotion, and/or the like.

Memory 1110 is optionally configured to store the prose associated with the candidate package. This prose can be from the author of the candidate package describing comments about the package, comments about changes made to the package, etc.

Memory 1110 is optionally configured to store the package bias scores associated with various aspects of the candidate packages.

Promotion Determination System 1100 optionally includes a Promotion Candidate Interview System 1162. Promotion Candidate Interview System 1162 is configured to interview candidates associated with a possible promotion. In addition, an optional step in Promotion Determination System 1100 is to use Promotion Candidate Interview System 1162 to interview references and other possible parties that are relevant to a decision about which candidate should be promoted during a promotion process. The use of Promotion Candidate Interview System 1162 limits the bias that can occur during the promotion process by reminding the interviewer of what is important for the job, ensuring all candidates (and other interviewees) are asked the same questions, and making interview feedback public to other interviewers, thereby increasing the accountability of interviewers.

Promotion Candidate Interview System 1162 is configured to facilitate the interviewing of candidates associated with a possible promotion. In addition, an optional step in Promotion Determination System 1100 is to use Promotion Candidate Interview System 1162 to interview references and other possible parties that are relevant to a decision about which candidate should be promoted during a promotion process. Promotion Candidate Interview System 1162 is optionally the same as described in FIG. 11 of Computer Mediated Tool for Conducting Job Interviews, Phone Screens, and Reference Checks (U.S. provisional patent application Ser. No. 62/085,822), which we will refer to as Promotion Candidate Interview System, according to various embodiments of the invention. Promotion Candidate Interview System 1162, a component of Promotion Determination System 1100, is used by the promotion board members determined by Promotion Board Selection System 1150 to interview candidates for the promotion being considered. In addition, Promotion Candidate Interview System is used by promotion board members to interview references for the promotion candidates. The importance of using Promotion Candidate Interview System 1162 is that this system attempts to remove as much bias as possible from the interview process. Following the interview process, the feedback given during the interviews are added to the candidate promotion package as it is defined in Promotion Candidate Package Builder System 1155.

Promotion Determination System 1100 optionally includes a Promotion Candidate Rating System 1165. Promotion Candidate Rating System 1165 is configured for each promotion board member to rate each candidate. The use of Promotion Candidate Rating System 1165 to rate each candidate reduces bias by showing each promotion board member where bias may be occurring in their evaluation of the candidate, the candidate's package, and the interviews they conducted as part of the review process. Showing the bias associated with the evaluation of the candidate, etc. helps to remove the bias that may occur as part of this review process.

Promotion Candidate Rating System 1165 optionally uses a part of Memory 1110 configured to store a set of board member profiles.

Promotion Candidate Rating System 1165 optionally further uses a part of Memory 1110 configured to store a set of profiles of one or more candidates associated with a possible promotion or set of promotions.

Promotion Candidate Rating System 1165 optionally further uses a part of Memory 1110 configured to store a set of packages associated with one or more candidates associated with a possible promotion or set of promotions.

Promotion Candidate Rating System 1165 optionally further uses a part of Memory 1110 configured to store information about various forms of biases, various indicators of those biases, various techniques for mitigating those biases and various descriptions of the biases, and/or the reasoning behind the biases and the mechanisms for mitigating the biases (rating bias data). Examples of things that can be stored in rating bias data include, but are not limited words and/or phrases that are known to be biased against gender, race, or some other demographic or stereotype (an example is using the word “aggressive” which is known to be used for female employees where “assertive” is usually used with male employees); the types of performance that should be evaluated for all employees (an example is rating every employee on both accomplishments and potential); including work tasks that tend to be typically female-oriented in the consideration of performance (for example, note taking in meetings, organizing parties, etc.); etc. Typically, rating bias data includes a data structured specifically configured to store this information.

Rating bias data optionally contains words or phrases that can be used as part of mitigation techniques for removing bias or descriptions of procedures that can be taken to remove bias from the review of a candidate's promotion package. Examples of data and procedures that can be used for mitigation techniques include but are not limited to changing a biased term to a neutral term (for example, changing “aggressive” to “assertive” or suggesting that promotion board members do not use the term “tone” in their review of the candidate promotion package), ensuring that all candidates are rated on both performance and potential, including typically female-oriented tasks (organizing parties) in rating the candidate for promotion for both male and female candidates, prompting the promotion board member to recall positive components of the employees past performance, prompting the promotion board member to recall negative components of the employees past performance, reminding the promotion board member of the aspects of the job that are important to the performance of the job, etc.

Promotion Candidate Rating System 1165 is optionally further configured to use part of Bias Scoring Logic 1135 to parse feedback by promotion board members about candidates and to calculate a score that is the indication of the amount of bias present in the candidate rating (a feedback bias score).

Example calculations that can be performed by the Bias Scoring Logic 1135 include, but are not limited to, the indication of biased terms, the lack of evaluating someone on performance or potential, and the lack of scoring someone on typically female-oriented tasks. An additional example reminds the promotion board member of the candidate rating about what is most important for performing in the job in which the person is being considered for promotion. As an example, since women can be judged as “not speaking up enough” and also “talking too much”, Promotion Candidate Rating System 1165 may optionally remind the promotion board member of the candidate rating that the most important aspects of the candidate rating are things like “accomplished goals set forth in performance plan”, and other quantifiable and relevant tasks associated with the whether or not the candidate will be able to do job for which they are being considered. An additional example uses the potential biases of the promotion board member to increase or decrease the feedback bias score based on some component of the candidate rating. For example, if the promotion board member is male, the candidate rating may be scored as more biased if the feedback bias scores for importance of typically female-oriented tasks are marked as less important than other tasks. Similarly, the feedback bias score may take into account the similarity of the promotion board member with the candidate. It has been shown that promotion board members tend to prefer candidates that are similar to them. Therefore, the feedback bias score may be adjusted to account for the fact that a promotion board member has a tendency to rate a candidate who is similar to them higher than a candidate who is less similar to them.

A promotion board member may enter and/or modify various components of a candidate rating. The calculation of the feedback bias score is based on the information stored in the Memory 1110 in combination with the various components of the candidate rating. The feedback bias score represents a result of a calculation of the various components of the rating bias data as a function of the information in the candidate rating. In various embodiments, there are a wide variety of methods by which a feedback bias score can be calculated. In some embodiments an equation (e.g., a linear equation) is used that includes bias values multiplied by coefficients. The coefficients are based on information such as magnitude of bias per component or number of existing components that represent bias among others.

The feedback bias score calculated using Bias Scoring Logic 1135 is typically configured for showing the user of the system, who is the promotion board member or modifier of the candidate rating, when their changes or additions to a candidate rating make that candidate rating more or less biased. The feedback bias score generated by Bias Scoring Logic 1135 can optionally be displayed in real-time and/or be displayed based on a previous calculation. An example of the feedback bias score being displayed in real-time includes when a board member types the word “abrasive”, the feedback bias score would change immediately and the word would be highlighted to show that it is known to be a word that is used when the promotion board member is biased. Bias Scoring Logic 1135 is optionally configured to calculate a grade based on a feedback bias score. A grade is a representation of a feedback bias score normalized to a grading scale such as A to F, 1 to 10, one star to five stars, “Very Good” to “Very Bad,” etc.

Bias Scoring Logic 1135 optionally includes Binary Calculation Logic 1140 and Non-Binary Calculation Logic 1145. Binary Calculation Logic 1140 is configured to calculate a feedback bias score based on binary values, such as the presence of a particular words or phrases in the candidate rating. For example, a candidate rating may include words or phrases like “abrasive” or “watch your tone” which have been shown to be included in female ratings, but less so in male ratings. In this case, a binary feedback bias score of one may be included indicating that the candidate rating is unfairly written to judge the employee on something that men are not typically judged on. Binary Calculation Logic 1140 may use Boolean logic. Binary Calculation Logic 1140 is typically used to dramatically alter feedback bias scores for specific components of the candidate rating that are absolutely to be avoided. Different factors can be weighted differently in the calculation.

Binary Calculation Logic 1140 optionally includes whether or not the candidate has been rated on both accomplishments and potential. It is shown that men tend to get more promotions and higher ratings because reviewers look at their potential in addition to their accomplishments. Women are often passed over for promotion or given lower ratings because the evaluator wants “proof” that a woman can perform in a certain way. Asking promotion board members about both achievements and potential in a systematic way, reduces the possibility that women will be rated lower than men when they have the same performance as a man.

Binary Calculation Logic 1140 optionally includes whether or not typically female-oriented tasks are included in the candidate rating. Because women are often tasked with typically female-oriented tasks (like taking notes in meetings, organizing parties, mentoring others, and the like), this can hurt the appearance of how well they performed since these tasks take up time but are often not counted towards their accomplishments. By prompting the promotion board member to indicate which typically female-oriented tasks have been accomplished by the candidate—and remind the reviewer that these tasks are important for the success of the organization—it reduces the likelihood that an employee who has contributed a lot of these typically female-oriented tasks will be rated lower than someone who has not performed many typically female-oriented tasks.

Binary Calculation Logic 1140 is optionally configured to calculate feedback bias scores based on whether the promotion board member has the possibility of being biased in any way. These calculations are based on a plethora of information including but not limited to the promotion board member's background, ethnicity, religion, preferences, age, level of education, results of psychological, personality or other tests, indications from the promotion board member's co-workers or managers, etc. These calculations can be based on how similar the promotion board member is to the candidate. It has been shown that board members tend to rate candidates who are similar to them higher than candidates who are less similar to them. Therefore, the feedback bias score may be adjusted based on the similarity of the board member to the candidate. This similarity can be determined algorithmically or can be determined by prompting the promotion board member to rate how similar they are to the candidate. This information can be used to increase or decrease the feedback bias score based on whether or not the promotion board member is likely to have a particular bias.

Non-Binary Calculation Logic 1145 is optionally configured to calculate a feedback bias score based on quantitative information within the candidate rating. For example, the calculation of a feedback bias score may include multiplying the number of biased words by a coefficient. The coefficient can be positive or negative.

Non-Binary Calculation Logic 1145 is optionally configured to calculate scores based on whether the promotion board member has the possibility of being biased in any way. These calculations are based on a plethora of information including but not limited to the promotion board member's background, ethnicity, religion, preferences, age, education level, results of psychological, personality or other tests, indications from the promotion board member's co-workers or managers, the similarity of the promotion board member to the candidate, etc. This information can be used to increase or decrease the feedback bias score based on whether or not the promotion board member is likely to have a particular bias.

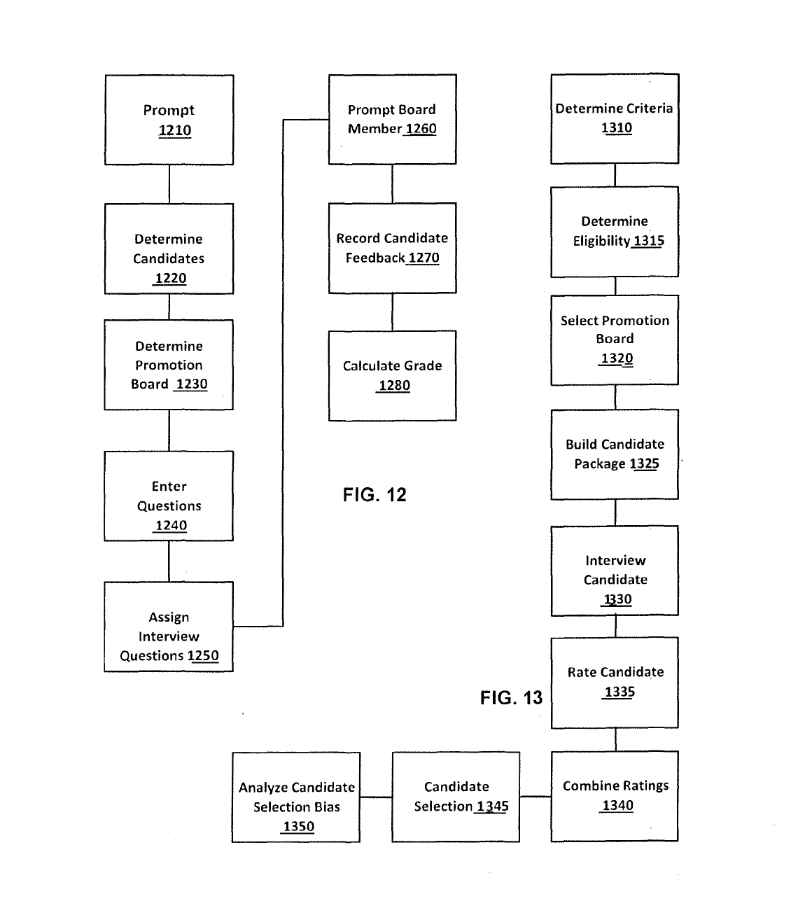

The steps specified by Promotion Candidate Rating System 1165, and other parts of Promotion Determination System 1100, for scoring candidates based on their viability for promotion are outlined below and illustrated in FIG. 12.

In a Prompt Step 1210, the promotion author indicates that he or she wants to determine a promotion, Promotion Candidate Rating System 165 prompts the promotion author to select the set of one or more candidates to be considered for promotion. In this case “promotion author” is the person who is in charge of coordinating the promotion process. This could be the hiring manager of the promotion position, a human resources professional, a recruiter, or another human person who is coordinating the promotion process.

In addition, in an optional Determine Candidates Step 1220, Promotion Candidate Rating System 1165 prompts the promotion author to indicate the candidates to be considered for promotion.

In addition, in an optional Determine Promotion Board Step 1230, Promotion Candidate Rating System 1165 prompts the promotion author to indicate the promotion board members to be included in rating the selected set of candidates.

In addition, in Prompt Step 1210, Promotion Candidate Rating System 1165 prompts the promotion author to determine the set of questions to be asked of each promotion board member about the candidates' promotion packages. The best types of questions to ask promotion board members are related to whether or not the promotion candidate will be able to perform the job associated with the promotion. Promotion Candidate Rating System 1165 provides a set of questions to the promotion author so that the promotion author can select which of these questions he or she wants the promotion board members to respond to based on the information in each candidate's promotion package. The questions presented to the promotion author can, but do not have to, be based on any of the following: the information in the job description, the criteria associated with the promotion, information recorded about priorities of criteria for the promotion, etc.

In addition, in an optional Enter Questions Step 1240, the promotion author can enter their own questions they want the promotion board members to consider when rating the candidates. In the case that promotion authors enter their own questions, Bias Scoring Logic 1135 can be used to determine if any of the questions entered by the promotion author contain indications of bias. Possible indications of bias could include, but are not limited to, asking about sports, asking about specific schools or educational background, asking questions that are not related to whether or not the candidate can perform the duties required of the job, asking questions related to anything that was indicated as a specific bias of the promotion author or promotion board member in the Memory 1110. In the case that bias is suspected, several possible actions can be taken. These actions include, but are not limited to notifying the promotion author that the question may be biased, recommending to the promotion author that the biased question be changed, recording that a biased question has been included, notifying a supervisor, recruiter or other individual that a biased question has been included, and/or not allowing the promotion author to use that question as part of the Promotion Candidate Rating System 1165.

Once the Determine Candidates Step 1220, the Determine Promotion Board Step 1230, and the Enter Questions Step 1240, have been completed, an optional Assign Interview Questions Step 1250 uses Non-Binary Calculation Logic 1145 to prompt the promotion author to assign a set of interview questions to each interviewer. Each of the questions that have been identified for use during the interview will be assigned to one or more interviewer to be asked. In some embodiments, each promotion board member is asked each question. In some embodiments particular promotion board members are asked some questions but not others. For example, if it is known that a promotion board member does not have expertise on software design, that promotion board member might not be asked to rate candidates' proficiency in software design. Similarly, if a particular board member is known to be biased toward candidates who attended Ivy League schools, that board member may not be asked to rate candidates based on education.

The Determine Candidates Step 1220 should be performed before the Determine Promotion Board Step 1230 and the Enter Questions Step 1240, but the Determine Promotion Board Step 1230 and the Enter Questions Step 1240 can be performed in any order.

Once Assign Interview Questions Step 1250 has been completed, Promotion Candidate Rating System 1165 optionally includes a Prompt Board Member Step 1260 that prompts the promotion author to request that each promotion board member rate each candidate. This request can be done by sending an email with a link to Promotion Candidate Rating System 1165, calling the promotion board member and requesting that they login to Promotion Candidate Rating System 1165 to enter their feedback, or a plethora of other methods for communicating that the promotion board member is requested to submit their feedback.

Once the candidates, promotion board members, and feedback questions have been selected, Promotion Candidate Rating System 1165 Prompt Board Member Step 1260 may optionally notify the promotion board members of the request for them to enter feedback for each candidate. An electronic or paper template could be provided to each promotion board member that facilitates the entering of feedback on the candidates as specified by the promotion author. This template could include, but is not limited to, the information stored in the promotion package of the candidate, the date and time of the review by the promotion board member, recommendations for how to conduct an unbiased review of the candidate, information about biases that are known for the promotion board member to make him or her aware of his or her biases, etc.

In a Record Candidate Feedback Step 1270 the board member is presented with the questions that have been assigned to him or her. These questions may optionally be accessed using Computing Devices 1175, such as a user's personal computer, cellular phone, tablet computer, telephone, or the like. Computing Devices 1175 are optionally configured to execute a browser such as Internet Explorer™ or FireFox™ and communicate with Promotion Candidate Rating System 1165 via this browser. In addition, these questions may be accessed via paper that has been printed from said Computing Devices 1175.

As part of Record Candidate Feedback Step 1270, the set of questions to be asked is optionally identified by Promotion Candidate Rating System 1165 as the set of questions assigned to the promotion board member who is accessing the system. Promotion Candidate Rating System 1165 provides the promotion board member an interface, often via a browser or mobile device, which allows the promotion board member to record feedback about the candidate and the components of the candidate's promotion package. Components of the candidate's promotion package include the package component bias scores associated with each component of the package. This feedback is optionally in the form of prose. In some cases this prose may indicate that the board member has disregarded a particular component of a candidate's package. For example, if a board member sees a very negative review of the candidate, the board member—outside of Promotion Candidate Rating System 1165—may request to see some or all reviews submitted by the review author of the review in question. If the board member determines that the review author tends to rate female employees much worse than male employees in some or all cases, the promotion board member may note in their prose that they decided to not consider the review in question due to a pattern of unfair reviews by the review author. In an optional embodiment the determination for which components are not used in determining the promotion is done automatically. As an example, if a package component bias score for a component of a package is greater than some value, X, then that component is removed from the promotion package or not shown to the promotion board member. There are many other methodologies for automatically determining which package contents might be used or discarded based on the package component bias scores associated with those packages. Optionally the promotion board member can also assign a rating based on the candidate's package or record some other indication as to how well the candidate will fit into the job. Package component bias scores can be numerical, on an A through F level or a multitude of other indications as to the proficiency of the candidate's response to the interview question.

As part of Record Candidate Feedback Step 1270, while the promotion board member is entering their feedback into Promotion Candidate Rating System 1165, the system will optionally remind the promotion board member of potential biases that the promotion board member possesses based on the information stored in Memory 1110. In addition, while the promotion board member is entering their feedback into Promotion Candidate Rating System 1165, the system will optionally remind the promotion board member that his or her feedback will be made available to the promotion author, hiring manager, and some or all other promotion board members. When the promotion board member knows that their feedback will be visible to other promotion board members visibility and, therefore, accountability of the feedback entered by some or all promotion board members tends to reduce the occurrence of promotion board members giving a candidate a poor review due to something that is not relevant to whether or not the candidate can perform the job.

As part of Record Candidate Feedback Step 1270, optionally, for each candidate or for each question per candidate, Promotion Candidate Rating System 1165 will ask each promotion board member to rate the candidate. Candidate ratings can be numerical values, A-F grades, or some other methodology for indicating the likelihood that the candidate will perform well at the job being considered.

As part of Record Candidate Feedback Step 1270, either as the promotion board member enters their feedback or after the feedback has been entered, Promotion Candidate Rating System 1165 uses Bias Scoring Logic 1135 to optionally analyze the words used in the feedback to determine if any bias exists. Optionally, information about bias data (stored in Memory 1110) is used by Bias Scoring Logic 1135 to determine if some bias may or may not exist in the feedback associated with the candidate's rating. The determination of bias made by Bias Scoring Logic 1135 can be binary, indicating that bias exists, on a spectrum, giving a candidate rating bias score of how much bias exists, or presented in some other way to notify some set of the promotion board members, the other promotion board members, the hiring manager, the promotion author or recruiters involved or other human resources professionals from the organization about possible biases. For example, using terms like “not a culture fit” can be an indication of bias as this phrase has been associated with promotion board members' desire to not promote someone without providing a concrete reason for the hire. Additionally, words like “emotional” or “personality” tend to be used detrimentally against women candidates more frequently than against male candidates. Occurrences of these types of words might be counted or the binary indication of the occurrence of these words might be shown or other algorithms might be used to compute a candidate rating bias score or an indication of bias.

In an optional Calculate Grade Step 1280, Candidate Rating Logic 1165 uses the feedback given by each of the promotion board members to determine a final rating (grade) for the candidate. Candidate Rating Logic 1165 can perform linear or non-linear calculations to determine a final rating for each candidate based on the feedback scores given to the candidate or to each question asked of the promotion board members. An example of a non-linear calculation could be a weighted average of the feedback scores based on an indication of the promotion author of how important each question is to the indication of whether or not the candidate will perform well in the job.

Promotion Candidate Rating System 1165 typically uses Presentation Logic 1160 configured to provide feedback scores and or grades to a promotion board member and to allow the promotion board member to make changes or additions to the candidate rating to influence their feedback score. In typical embodiments, Presentation Logic 1160 is configured to generate computing instructions (e.g., html, xml, scripts, java, or the like) configured to present an interface to a promotion author within a browser. Alternatively, Presentation Logic 1160 is configured to present information to a promotion author via a software agent. Part of Presentation Logic 1160 is optionally disposed on Computing Device 1175A.

Promotion Candidate Rating System 1165 typically includes a method of providing feedback on a candidate based on the various components of the candidates' package or packages.

In Record Candidate Feedback Step 1270 the promotion author is presented with questions that have been assigned to him or her by the person who compiled the board. These questions may optionally be accessed using Computing Devices 1175, such as a user's personal computer, cellular phone, tablet computer, telephone, or the like. Computing Devices 1175 are optionally configured to execute a browser such as Internet Explorer™ or FireFox™ and communicate with Promotion Determination System 1100 via this browser. In addition, these questions may be accessed via paper that has been printed from said Computing Devices 1175.

FIG. 13 illustrates a method for selecting a candidate for promotion.

In an optional Determine Criteria Step 1310, criteria for a promotion are determined using Job Criteria Builder System 1120.

In an optional Determine Eligibility Step 1315, eligibility for a plurality of candidates is determined using Promotion Candidate Determination System 1125.

In an optional Select Promotion Board Step 1320, a promotion board is selected using Promotion Board Selection System 1150.

In a Build Candidate Package Step 1325, a Candidate package is built using Promotion Candidate Package Builder System 1155

In an optional Interview Candidate Step 1330, the plurality of candidates is each interviewed using Promotion Candidate Interview System 1162.

In an optional Rate Candidate Step 1335, each of the candidates is rated using Promotion Candidate Rating System 1165.

In a Combine Ratings Step 1340, ratings from each of the promotion board members are combined (for each candidate).

In Candidate Selection Step 1345, the candidate that will be promoted is selected either by the promotion author, by the promotion board, or by some other human or computer actor. If the promotion board makes the decision of which candidate will be promoted, this can be done through majority vote, unanimous vote or some other alternative method identified by the promotion author, the promotion board, or some other human actor.

In this method grades or feedback scores for several candidate ratings are calculated or retrieved and provided to a promotion author or others for comparison. Also, multiple grades for the same candidate can be displayed in a time-series for comparison by the promotion author or others. For example, if a candidate received a grade of “C” on January 1 and was modified on January 2 and then received a grade of “B”, a time-series chart could show the promotion author or others the change to the feedback score of the candidate rating as changes were made.

In addition, candidate ratings aggregated for a group of candidates can be displayed. For example, the promotion author or the members of the promotion board might want to see the ratings for some or all candidates being considered for the promotion.

An optional Analyze Candidate Selection Bias Step 1350 uses Binary Calculation Logic 1140 and Non-Binary Calculation Logic 1145 to determine whether bias is present in the selection of the candidate. Analyze Candidate Selection Bias Step 1350 can be used to make adjustments to which candidate is selected for promotion, notify interested parties (recruiters, human resources professionals, compliance people, etc.) about possible bias in the promotion process, and so on.

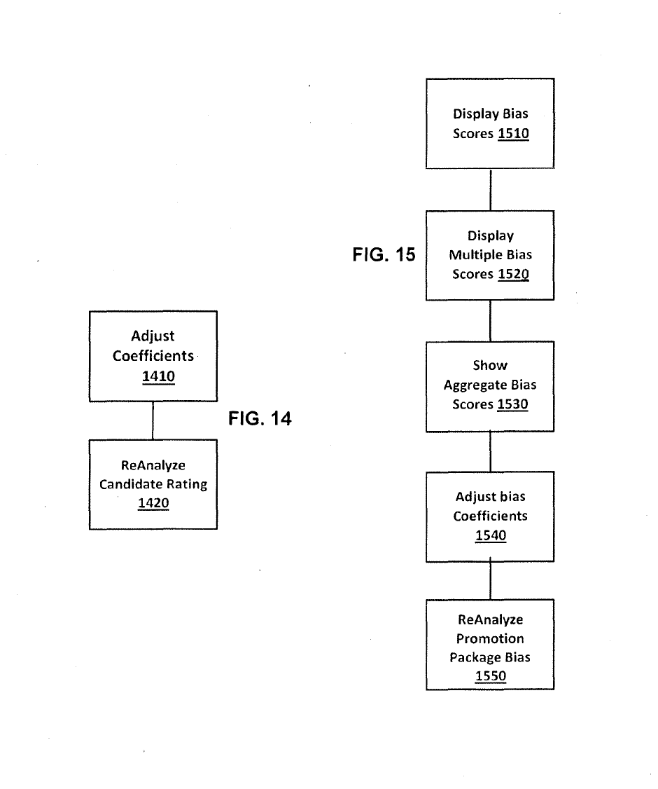

FIG. 14 shows an optional Adjust Coefficients Step 1410 wherein coefficients used by Binary Calculation Logic 1140 and Non-Binary Calculation Logic 1145 are adjusted based on the changes to the ratings of the candidate's promotion package. Adjust Coefficients Step 1410 can be executed because of bias recognized in Analyze Candidate Selection Bias Step 1350. As a result, feedback scores for some or all of the candidate ratings associated with those coefficients may change based on a change to the coefficients. In this embodiment, a ReAnalyze Candidate Rating Step 1420 can be run to re-analyze the candidate package in the class for which the coefficients have been adjusted.

In the case of the ReAnalyze Candidate Rating Step 1420 being run, the previous ratings of the candidates are stored and an additional value is stored as candidate rating bias data in the Memory 1110 to indicate that a change was made to the coefficients prior to this running of the grading of the candidates.

Thus, in FIG. 14 when candidate grades or ratings are displayed, an indication is shown to the promotion author or others through the Presentation Logic 1160 that there was a change to the coefficients prior to obtaining the displayed grade.

FIG. 15 is an illustration of a method for comparing rating bias scores across candidates and within a promotion process, according to various embodiments of the invention. In this method, Display Bias Scores Step 1510 shows grades or rating bias scores that show the bias associated with the promotion process for one or several candidate are calculated or retrieved and provided to a promotion author or others for comparison. Also, in an optional Display Multiple Bias Scores Step 1520 multiple grades for the same candidate set of candidates or promotion process can be displayed in a time-series for comparison by the promotion author or others. For example, if the rating bias score associated with the promotion package for candidate X is a grade of “C” on January 1 and the promotion package for the same candidate was modified on January 2 and then received a rating bias score grade of “B”, a time-series chart could show the promotion author or others the change to the rating bias score as changes to the candidate package were made.

In addition, an optional Show Aggregate Bias Scores Step 1530 shows rating bias scores aggregated for a group of candidates can be displayed. For example, the promotion author or the members of the promotion board might want to see the rating bias scores for the promotion packages for some or all candidates being considered for the promotion.

The steps illustrated by FIG. 15 are optionally performed using Promotion Determination System 1100. The steps illustrated in FIG. 15 may be utilized in a wide variety of alternative orders.

In an optional Adjust Bias Coefficients Step 1540 coefficients used by Bias Scoring Logic 1135 are adjusted based on the tolerance for various types of biases. As a result, promotion selection bias scores for some or all of the candidate ratings associated with those coefficients may change based on a change to the coefficients. In this embodiment, a ReAnalyze Promotion Package Bias Step 1550 can be run to re-analyze the bias associated with candidate ratings and candidate promotion packages in the class for which the coefficients have been adjusted.

In the case of the ReAnalyze Promotion Package Bias Step 1550 being run, the previous rating bias scores for the candidate promotion packages are stored and an additional value is stored in Memory 1110 to indicate that a change was made to the coefficients prior to this running of the grading of the candidates.

1. (canceled)

2. A computing system configured to reduce bias in the authoring of a set of criteria required for a promotion, the computing system comprising:
a user interface configured to a human user to enter words of the criteria set;
a rule base comprising a plurality of rules for the content of a criteria in the criteria set, the plurality of rules including
a rule about the inclusion of certain criteria in the set of criteria, and
a rule to avoid specific terms in the set of criteria;
analysis logic configured to generate a score for the set of criteria, the score being based on compliance of the criteria to the plurality of rules;
storage configured to store the criteria and the plurality of rules; and
a microprocessor configured to execute at least the analysis logic.

3. The system of claim 2, wherein the user interface includes a wizard configured to guide the user to enter parts of the criteria one part at a time.

4. The system of claim 2, wherein the rule to avoid specific terms is a rule to avoid specific gender biased terms.

5. The system of claim 2, wherein the rule to avoid specific terms is a rule to avoid specific racial biased terms.

6. The system of claim 2, wherein the rule to avoid specific terms is a rule to avoid specific age biased terms.

7. The system of claim 2, wherein the rule to avoid specific terms is a rule to avoid specific sexual preference biased terms.

8. The system of claim 2, wherein the rule to avoid specific terms is a rule to avoid specific terms biased toward education level.

9. The system of claim 2, wherein the rule to avoid specific terms is a rule to avoid specific terms biased toward religion.

10. The system of claim 2, wherein the rule to include criteria that are known to be typically female-gendered.

11. A computing system configured to reduce bias in the selection of a candidate set to be considered for a promotion, the computing system comprising:
a user interface configured to a human user to interact with information about possible promotion candidates including
reading the qualifications of a possible promotion candidate,
viewing the criteria associated with the promotion relative to qualifications of the possible promotion candidates, and
ranking the candidates relative to each other;
a rule base comprising a plurality of rules for the selection of promotion candidates, the plurality of rules including
a rule determining if there are possible promotion candidates that have not been included in the promotion candidate set that meet all of the criteria,
a rule determining if there are possible promotion candidates that have been included in the promotion candidate set that do not meet all of the criteria, and
a rule to determine whether the person choosing the candidate set has any bias towards or against any of the candidates;
analysis logic configured to generate a score for the candidate set, the score being based on compliance of the candidate set to the plurality of rules;
storage configured to store the candidate set and the plurality of rules; and
a microprocessor configured to execute at least the analysis logic.

12. The system of claim 11, wherein the user interface includes a wizard configured to guide the user to view candidates and their qualifications.

13. The system of claim 11, wherein the user interface is further configured for the human user to view a plurality of criteria associated with the promotion.

14. The system of claim 11, wherein the user interface is further configured for the human user to view the bias present in the selected candidate set based on the analysis performed.

15. The system of claim 11, wherein the user interface is further configured for the human user to indicate which candidates will be considered in the promotion process.

16. A computing system configured to reduce bias in the selection of a set of board members to determine a promotion, the computing system comprising:
a user interface configured to a human user to interact with information about possible board members including
reading the information about a possible promotion board member,
viewing the information associated with the promotion board member relative to the promotion board member's demographic information, employment information etc., and
determine which possible board members will be included in the promotion board;
a rule base comprising a plurality of rules for the selection of members of the promotion board, the plurality of rules including
a rule determining if there is enough gender diversity on the promotion board,
a rule determining if there is enough racial diversity on the promotion board,
a rule determining if there is enough diversity along other demographic lines on the promotion board,
a rule determining if any of the promotion board members know any of the candidates and
a rule to determine whether the person choosing the candidate set has any bias towards or against any of the promotion board members;
analysis logic configured to generate a score for the set of promotion board members, the score being based on compliance of the set of promotion board members to the plurality of rules;
storage configured to store the set of promotion board members and the plurality of rules; and
a microprocessor configured to execute at least the analysis logic.

17. The system of claim 16, wherein the user interface includes a wizard configured to guide the user to view possible promotion board members and their demographics.

18. The system of claim 16, wherein the user interface is further configured for the human user to view a set of possible promotion board members and whether or not the possible promotion board members know any of the promotion candidates.

19. The system of claim 16, wherein the user interface is further configured for the human user to view the bias present in the selected promotion board set based on the analysis performed.

20. The system of claim 16, wherein the user interface is further configured for the human user to indicate which possible promotion board members will be part of the promotion board.

21. The system of claim 16, wherein the user interface includes a wizard configured to guide the user to enter ratings associated with the candidate's promotion package, including the results of any interviews, one component at a time.
